(19) United States
(12) Patent Application Publication
(10) Pub. No.: US 2013/0254179 A1
(43) Pub. Date: Sep. 26, 2013

(54) SYSTEMS AND METHODS FOR BRAND ENFORCEMENT

(71) Applicant: Brand Enforcement Services Limited, Hong Kong (CN)

(72) Inventor: Edwin Tan, Beaverton, OR (US)

(73) Assignee: Brand Enforcement Services Limited, Hong Kong (CN)

(21) Appl. No.: 13/836,533

(22) Filed: Mar. 15, 2013

Related U.S. Application Data
(63) Continuation-in-part of application No. 13/164,541, filed on Jun. 20, 2011.
(60) Provisional application No. 61/652,077, filed on May 25, 2012.
(60) Provisional application No. 61/356,559, filed on Jun. 19, 2010.
(60) Provisional application No. 61/356,560, filed on Jun. 19, 2010.
(60) Provisional application No. 61/356,561, filed on Jun. 19, 2010.
(60) Provisional application No. 61/356,562, filed on Jun. 19, 2010.
(60) Provisional application No. 61/356,563, filed on Jun. 19, 2010.
(60) Provisional application No. 61/356,564, filed on Jun. 19, 2010.

(51) Int. Cl. G06F 17/30

(52) U.S. Cl. CPC G06F 17/30864
USPC 707/706

(57) ABSTRACT

Systems and methods for brand monitoring, protection, and expansion are provided. More specifically, various embodiments of the present invention relate to systems and methods for tracking and enforcing trademark rights and identifying domain names and websites of interest. Some embodiments use various techniques and methods for obtaining data pertaining to a domain name of interest. A GUI can be used for obtaining input from a user and displaying reports to the user. The user can submit a domain name and a list of key words, and the system can return a list of matching domain names, from which the user selects one or more domain names of interest. A watch can be placed on each domain name of interest. Various data about the domain name of interest is cached allowing for a historical analysis of the website which can be used to make better brand enforcement and expansion decisions.

### CROSS-REFERENCE TO RELATED APPLICATIONS

This application claims priority to U.S. Provisional Application Ser. No. 61/652,077 filed May 25, 2012, and is a continuation-in-part of U.S. application Ser. No. 13/164,541 which claims priority to U.S. Provisional Application Ser. Nos. 61/356,559 filed Jun. 19, 2010; 61/356,560 filed Jun. 19, 2010; 61/356,561 filed Jun. 19, 2010; 61/356,562 filed Jun. 19, 2010; 61/356,563 filed Jun. 19, 2010; and 61/356,564 filed Jun. 19, 2010, all of which are incorporated herein by reference for all purposes.

### TECHNICAL FIELD

Various embodiments of the present invention generally relate to systems and methods for brand monitoring, protection, and expansion. More specifically, various embodiments of the present invention relate to systems and methods for tracking and enforcing trademark rights and identifying domain names and websites of interest.

### BACKGROUND

Trademark infringement is common in connection with domains on the Internet. If a user creates a successful website having a given domain name or trademark, others will create copy sites with the same or very similar domain names or trademarks. To ensure protection of domain names and trademarks on the web, it is necessary to conduct searches to discover what domain names and trademarks are in use. If an individual wishes to introduce a new domain name, such a search is also necessary to determine whether that name is already in use.

Various web-based services exist under the WHOIS rubric to obtain data pertaining to domain names. Typically a user enters a domain name in the graphical user interface of a search engine, a search is conducted, and a list of results is displayed to the user. These traditional services have two common problems. First, they present data obtained at a specific moment in time, the current moment, but do not present data obtained at different moments of time in a historical picture. Second, the same data request made in different geographical regions may obtain different data in different regions. Current services do not allow the user to specify the region(s) at which the data requests are to be made. In the context of brand protection, these problems can limit the information obtained. Consequently, improved techniques are needed for effectively monitoring and enforcing trademark rights.

### SUMMARY

Various embodiments of the present invention generally relate to systems and methods for tracking and enforcing trademark rights and identifying domain names and websites of interest. Certain embodiments of the present invention teach a variety of improved methods and systems for obtaining and displaying data pertaining to domain names of interest to a user.

Various embodiments of the present invention provide for a method that includes receiving search data related to a plurality of entity names. The search data related to the plurality of entity names can be submitted to a brand enforcement engine to identify a set of domains of interest (e.g., cybersquatters, domains selling products related to the any of the plurality of entity names, domains available for purchase, etc.). Tracking data can be returned from the brand enforcement engine. The tracking data (e.g., images from the set of domains of interest collected during an internet search) may include information regarding the set of domains identified by the brand enforcement engine. In some embodiments, the tracking data can include a traffic analysis, a content analysis, a value analysis, and/or an enforcement value. Using a processor, a dashboard may be populated with a summary of the tracking data organized by the plurality of entity names. In some cases, the dashboard may include a categorization of the identified domain names into a plurality of categories (e.g., a spam category, a social media category, a news category, a phishing category, etc.).

In accordance with various embodiments, a brand enforcement system may include a portal, an interface module, an enforcement module, an analysis module, a relation module, and/or other components. The portal can allow a user to access a brand enforcement engine and a set of databases that have an associated set of trademarks with the user. The interface module can generate a dashboard presenting potentially infringing domain names associated with the set of trademarks. The enforcement module may receive a request from the user to enforce one of the trademarks and to initiate an enforcement action upon receiving the request from the user.

The analysis module can be used to generate an analysis of one of the potentially infringing domain names upon selection by the user. The relation module can generate a set of secondary entity names related to the set of trademarks and to generate a relevance score associated with each of the secondary entity names. The dashboard may present the set of secondary entity names related to the set of trademarks and the relevance score associated with each of the secondary entity names. In some embodiments, the relevance score based on the degree of phonetic similarity between a given secondary entity name and one of the trademarks from the set of trademarks, the degree of likelihood the given secondary entity name is a typo of one of the trademarks from the set of trademarks, and/or a yearly revenue earned by an owner of the given secondary entity name.

In some embodiments, a computer-implemented method can include generating, using a processor, a snapshot interface with a list of entity names received from a brand enforcement engine in response to a submission of target names. The snapshot interface may include a statistical summary of infringers organized by the target names and may be displayed on a terminal device. An enforcement interface can also be generated and displayed upon selection of one of the target names, wherein the enforcement interface indicates existing enforcement actions and allows a user to initiate an enforcement action. In some cases, an enforcement authorization status (a senior level and a junior level) of a user may need to be determined. If the user has a senior level enforcement authorization, then the enforcement action submitted through the enforcement interface is automatically approved. If, however, the user has a junior level enforcement authorization, then the enforcement action submitted through the enforcement interface is forwarded to a second user for review.

While multiple embodiments are disclosed, still other embodiments of the present invention will become apparent to those skilled in the art from the following detailed description, which shows and describes illustrative embodiments of the invention. As will be realized, the invention is capable of modifications in various aspects, all without departing from the scope of the present invention. Accordingly, the drawings and detailed description are to be regarded as illustrative in nature and not restrictive.

### BRIEF DESCRIPTION OF DRAWINGS

Embodiments of the present invention will be described and explained through the use of the accompanying drawings in which:

FIG. 1 is a list of domain names obtained as the result of a search on a domain name of interest according to an embodiment;

FIG. 2 is a pictorial illustration of a cache of information pertaining to a domain name of interest according to another embodiment;

FIG. 3 is a pictorial illustration of a cache of information pertaining to domain names related to a domain name of interest, where the information is similar to information pertaining to the domain name of interest;

FIG. 4 is a representation of a timeline scroller according to one embodiment;

FIG. 5 is a pictorial representation of a timeline viewport according to embodiment;

FIG. 6 is a pictorial illustration of an interface for selecting one or more geographical regions from which to request information pertaining to a domain name of interest according to yet another embodiment;

FIG. 7 is a pictorial illustration of the view map interface;

FIG. 8 is a flow chart detailing the cache of information mentioned previously in connection with FIG. 3;

FIG. 9 is a flow chart describing the behavior of an example timeline scroller;

FIG. 10 is a flow chart detailing the selection of a geographical region from which to request data pertaining to a domain of interest mentioned previously in connection with FIG. 6;

FIG. 11 is a flow chart detailing the view map interface mentioned previously in connection with FIG. 7;

FIG. 12 is a flow chart describing the data that is similar to the data pertaining to a domain name of interest mentioned previously in connection with FIG. 3;

FIG. 13 illustrates the functions performed by a junior user using the trademark service;

FIG. 14 illustrates the functions performed by a senior user using the trademark service;

FIGS. 15A through 15I illustrate an exemplary setup offered by a trademark enforcement service for a junior user;

FIGS. 16A through 16D illustrate an exemplary setup offered by a trademark enforcement service for a senior user;

FIG. 17 illustrate how IDScore can be incorporated into the dashboard provided by the trademark service;

FIGS. 18A-18E illustrate exemplary graphical user interfaces that may be used within some embodiments;

FIGS. 19A-19E illustrate additional exemplary graphical user interfaces that may be used within one or more embodiments; and

FIG. 20 illustrates an example of a computer system with which some embodiments of the present invention may be utilized.

The drawings have not necessarily been drawn to scale. For example, the dimensions of some of the elements in the figures may be expanded or reduced to help improve the understanding of the embodiments of the present invention. Similarly, some components and/or operations may be separated into different blocks or combined into a single block for the purposes of discussion of some of the embodiments of the present invention. Moreover, while the invention is amenable to various modifications and alternative forms, specific embodiments have been shown by way of example in the drawings and are described in detail below. The intention, however, is not to limit the invention to the particular embodiments described. On the contrary, the invention is intended to cover all modifications, equivalents, and alternatives falling within the scope of the invention as defined by the appended claims.

### DETAILED DESCRIPTION OF THE INVENTION

Trademark infringement is common in connection with domains on the Internet. If a user creates a successful website having a given domain name or trademark, others will create copy sites with the same or very similar domain names or trademarks. To ensure protection of domain names and trademarks on the web, it is necessary to conduct searches to discover what domain names and trademarks are in use. If an individual wishes to introduce a new domain name, such a search is also necessary to determine whether that name is already in use.

Traditional web-based services present data (e.g., from a WHOIS search) obtained at a specific moment in time, i.e., the current moment, but do not present data obtained at different moments of time in a historical picture. These tools are not able to notify trademark owners of changes in websites that are being monitored. In addition, the same data request made in different geographical regions may obtain different data in different regions. Current services do not allow the user to specify the region(s) at which the data requests are to be made.

In contrast, various embodiments of the present invention provide for systems and methods that use a historical approach to allow a user to evaluate and/or establish a watch on a domain name of interest. In some embodiments, the systems and methods obtain snapshots of data pertaining to that domain name over time. Data obtained at different time periods may be compared and any changes can be presented to the user in summary form. The user can also scroll through snapshots of data taken at various times to compare images, html source code, and other information about the domain name of interest that has been collected. Still yet, the tools and methods may be used for monitoring the price of various products. Using the snapshots of the websites, the user can be presented with pricing information over time aggregated by product, website, geographical location, or other differentiators.

In addition, some embodiments of the present invention also permit the user to specify the region(s) at which data requests are made. For example, the user may specify that she wishes to obtain the data for a domain name that is obtained if the data is requested from a location in the East of the United States, from a location in Southeast Asia, or both.

In some instances, the systems can be used for domain name management with defensive registrations, brokerage services, acquisition services, escrow services, and others. To facilitate the domain name management, some embodiments permit a user to obtain a list of domain names having data that is similar to the data of a domain name of interest and data pertaining to those domain names. This information may include domain names having the same owner or the same name server as the domain name of interest. This information may help to protect against infringement.

In accordance with various embodiments, some system variations allow for the monitoring of the availability (e.g., are they currently for sale) of various domain names that may be of interest to the user. For example, the system can monitor domain name sales storefronts and auction sites. If a domain name related to the trademark becomes available, an alert can be displayed or sent to the user and the user can indicate whether to purchase the domain name or not. In some embodiments, the user can provide a list of domain names of interest or the system may identify and/or rank domain names of interest based. In order to identify and/or rank domain names of interest, the system may rely on past browsing history by users, content matching, historical indexed content matching (e.g., content included various keywords, trademarks, competitor products/trademarks, phishing sites, etc. over time), traffic statistics, and other factors.

Many different tools and techniques can be used for identifying a domain name of interest to a user. In some cases, the user may specify a plurality of entity names (e.g., trademarks, logos, images, domain names, etc.) of interest. A monitoring module can be used to monitor the entity names along with any identified variants of the entity names (e.g., based on phonetic similarity, common misspellings, etc.). Snapshots of the websites associated with the domain names can be collected (or cached) over time and indexed within a database. In some embodiments, the systems may cache data pertaining to a domain name of interest at predefined schedule, upon detection of an event (e.g., content change, ownership change, etc.), periodic intervals, or random intervals. The content of the websites can be compared against a set of trademarks or entity names and scored. Any matches above a specified threshold can be presented to the user through one or more graphical user interfaces.

Yet another embodiment teaches a computer-implemented method of obtaining data pertaining to domain names related to a domain name of interest, where the data of the related names is similar to the data pertaining to the domain name of interest. In a further embodiment, a computer-implemented timeline scroller allows a user to view snapshots of data pertaining to a domain name of interest taken at various points in time. Another aspect teaches a computer-implemented method for providing a timeline viewport that allows a user to view major changes that have taken place in a particular domain of interest at different points in time. In yet other embodiments, a computer-implemented method allows a user to place requests from various geographical regions for data pertaining to a domain name of interest; and provides a view map that allows a user to specify a geographical region of interest by marking a map in the interface—domain names of interest that are registered in the region of interest are highlighted on the map and in the list of domain names of interest.

In the following description, for the purposes of explanation, numerous specific details are set forth in order to provide a thorough understanding of embodiments of the present invention. It will be apparent, however, to one skilled in the art that embodiments of the present invention may be practiced without some of these specific details.

While, for convenience, embodiments of the present invention are described with reference to trademark and domain name brand enforcement, embodiments of the present invention are equally applicable to various other brand related elements such as, but not limited to, slogans, products, product features, product pricing models, and others. In addition, various embodiments of the present invention are also applicable to processing various pricing structures (e.g., allowing access to different features and/or tiers of service), distribution and delivery models (e.g., distributed computing or standalone applications), and/or interfaces.

The techniques introduced here can be embodied as special-purpose hardware (e.g., circuitry), or as programmable circuitry appropriately programmed with software and/or firmware, or as a combination of special-purpose and programmable circuitry. Hence, embodiments may include a machine-readable medium having stored thereon instructions which may be used to program a computer (or other electronic devices) to perform a process. The machine-readable medium may include, but is not limited to, floppy diskettes, optical disks, compact disc read-only memories (CD-ROMs), magneto-optical disks, ROMs, random access memories (RAMs), erasable programmable read-only memories (EPROMs), electrically erasable programmable read-only memories (EEPROMs), magnetic or optical cards, flash memory, or other type of media/machine-readable medium suitable for storing electronic instructions.

### Terminology

Brief definitions of terms, abbreviations, and phrases used throughout this application are given below.

The terms “connected” or “coupled” and related terms are used in an operational sense and are not necessarily limited to a direct physical connection or coupling. Thus, for example, two devices may be coupled directly, or via one or more intermediary media or devices. As another example, devices may be coupled in such a way that information can be passed therebetween, while not sharing any physical connection with one another. Based on the disclosure provided herein, one of ordinary skill in the art will appreciate a variety of ways in which connection or coupling exists in accordance with the aforementioned definition.

The phrases “in some embodiments,” “according to various embodiments,” “in the embodiments shown,” “in one embodiment,” “in other embodiments,” and the like generally mean the particular feature, structure, or characteristic following the phrase is included in at least one embodiment of the present invention, and may be included in more than one embodiment of the present invention. In addition, such phrases do not necessarily refer to the same embodiments or different embodiments.

If the specification states a component or feature “may”, “can”, “could”, or “might” be included or have a characteristic, that particular component or feature is not required to be included or have the characteristic.

The term “responsive” includes completely or partially responsive.

The term “module” refers broadly to a software, hardware, or firmware (or any combination thereof) component. Modules are typically functional components that can generate useful data or other output using specified input(s). A module may or may not be self-contained. An application program (also called an “application”) may include one or more modules, or a module can include one or more application programs.

The term “network” generally refers to a group of interconnected devices capable of exchanging information. A network may be as few as several personal computers on a Local Area Network (LAN) or as large as the Internet, a worldwide network of computers. As used herein “network” is intended to encompass any network capable of transmitting information from one entity to another. In some cases, a network may be comprised of multiple networks, even multiple heterogeneous networks, such as one or more border networks, voice networks, broadband networks, service provider networks, Internet Service Provider (ISP) networks, and/or Public Switched Telephone Networks (PSTNs), interconnected via gateways operable to facilitate communications between and among the various networks.

### General Description

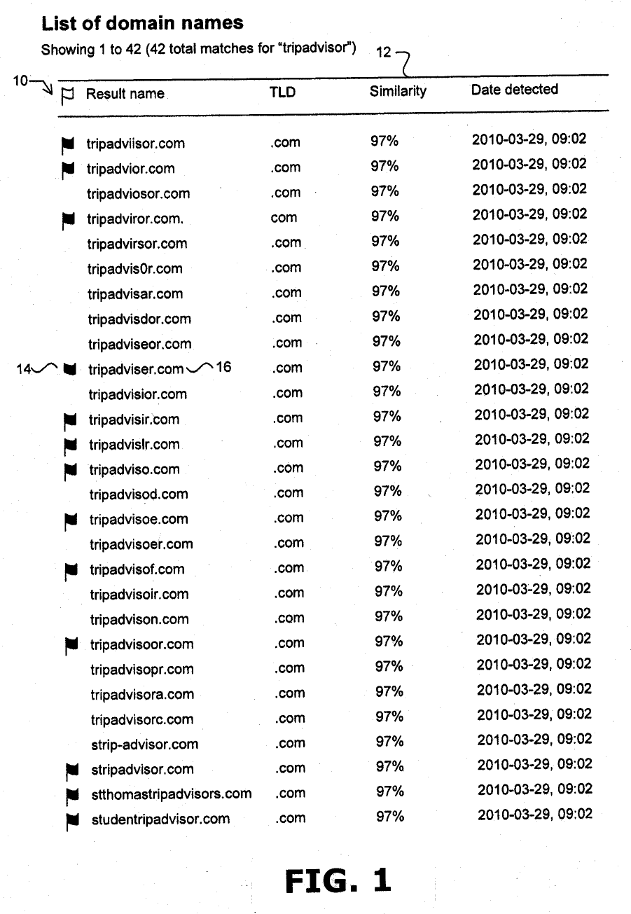

FIG. 1 is a list of domain names 10 obtained as a result of a search on the domain name ‘tripadvisor’ according to one example in a specific embodiment. In this example, a user enters the domain name ‘tripadvisor’ (“domain of interest”) in a graphical user interface of a system according to one embodiment. Here the user may be interested in searching for historical or present data, and/or may be considering initiating a watch service on certain similar domains. In response to the user's search query, the system performs a search, and displays a list of names 10 that match or are similar to the domain of interest entered by the user.

The search to determine similar domains can utilize any suitable criteria for such similarity determination, and in some embodiments a similarity measure 12 is calculated. For example, there may be a direct similarity match between the letters/words/phrases/characters in the domain of interest and the similar domain(s). Additionally, when images from the domain of interest are found in identical or similar form on the similar domain(s), this is an indication of similarity.

In some embodiments for identifying similar domains, keywords are identified as associated with the similar domains. Keywords may be searched out from a variety of sources including text in identified domains, metadata, recognized in images, and/or the domain html. In certain instances, if keywords are purchased as adwords associated with the similar domain(s), this may be an indication of similarity. The keywords of interest may be defined by the user directly, and/or the system may define relevant keywords. The system may, e.g., identify relevant keywords by analysis of the domain of interest.

Continuing on with FIG. 1, the graphical user interface enables domains identified as similar to be marked as of specific interest, by the user and/or by the system. In the example of FIG. 1, flag icons such as flag icon 14 identify that a domain 16 has been marked, and a watch is placed on the flagged domain names. In other embodiments, the user can manually indicate that a given domain has the similar quality, and thus the given domain can be “watched,” and information about that given domain provided and/or tracked for the user.

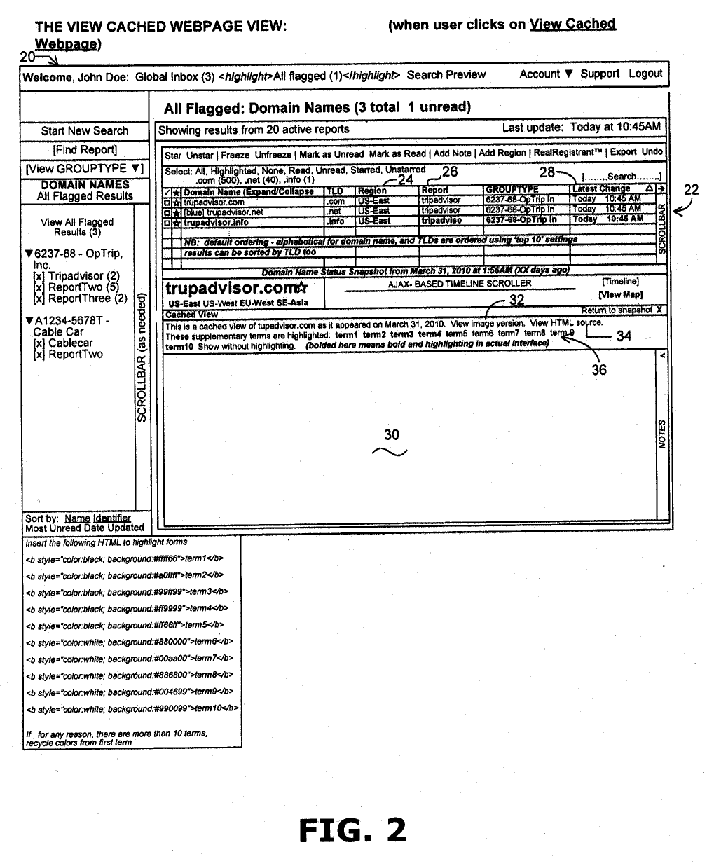

FIG. 2 is a pictorial illustration of an interface 20 for displaying and accessing a cache of information pertaining to the domain name ‘trupadvisor.com’, according to one embodiment. As will be appreciated, this is simply one specific example presented for demonstrative purposes. The interface 20 shows, among other things, three flagged domain names 22 (‘trupadvisor.com’, ‘trupadvisor.net’, and ‘trupadvisor.info’), a geographical region 24 from which the cache information was obtained (US-East), a report 26 to which the cache belongs (tripadvisor), and a time 28 of the latest change in the information. The snapshot information is displayed in a window 30 at the bottom of the screen. To view screenshots of the domain trupadvisor.com, the user clicks on ‘View image version’ text button 32. To view the html source code for the domain, the user clicks on ‘View HTML source’ text button 34. Keywords 36 defined by the user and/or the system that appear in the snapshot information are listed and highlighted above the window 30.

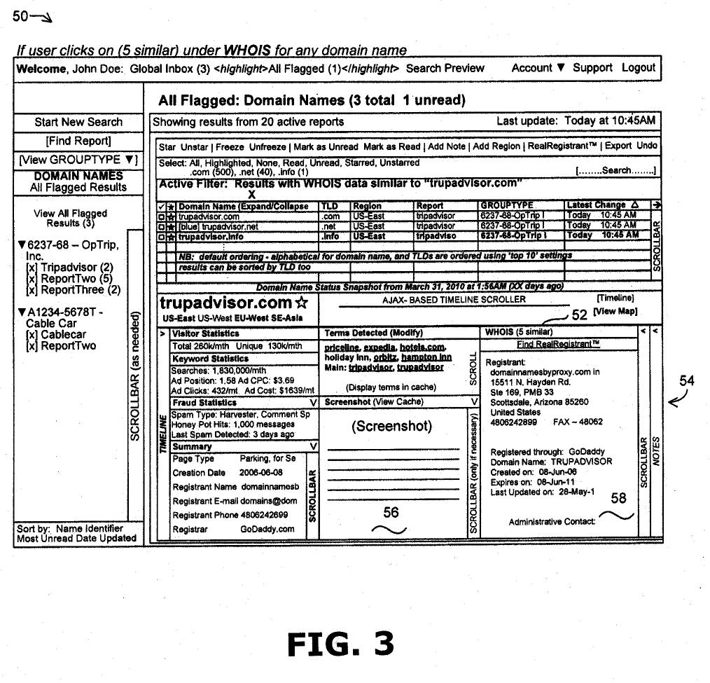

FIG. 3 is a pictorial illustration of an interface 50 for displaying and accessing a cache of information pertaining to domain names that have WHOIS data that is similar to the WHOIS data for trupadvisor.com, according to one embodiment of the present invention. As described above, trupadvisor.com was identified as similar to the domain of interest tripadvisor.com. Identifying information related to this or similar domains, such as domains with similar WHOIS information, can be useful in analyzing a potential infringer. If the user clicks on ‘5 similar’ under WHOIS 52 at the lower right 52 of a window 54, a filter is applied to the WHOIS data, and only data that is similar to the WHOIS data for trupadvisor.com is displayed. Screenshot data is displayed in a center bottom window 56; other metadata such as the name of the registrant (owner) or the name server of the similar domain names is displayed in a bottom right window 58 under ‘5 similar’.

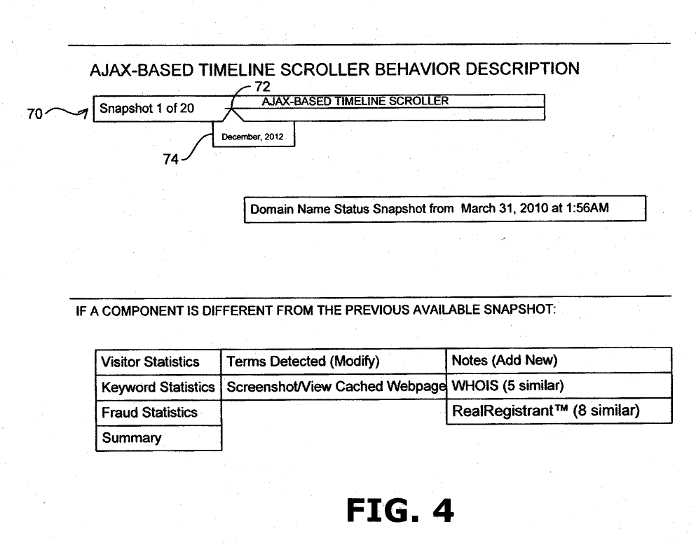

FIG. 4 represents a timeline scrollbar 70 according to one embodiment of the present invention. When a user selects a position 72 on the timeline scrollbar 70, an anchor 74 appears that displays the date of the current snapshot, and the number of the current snapshot is displayed by the scrollbar 70. If the user drags the selection to the left, earlier snapshots are displayed; if the user drags the selection to the right, later snapshots are displayed.

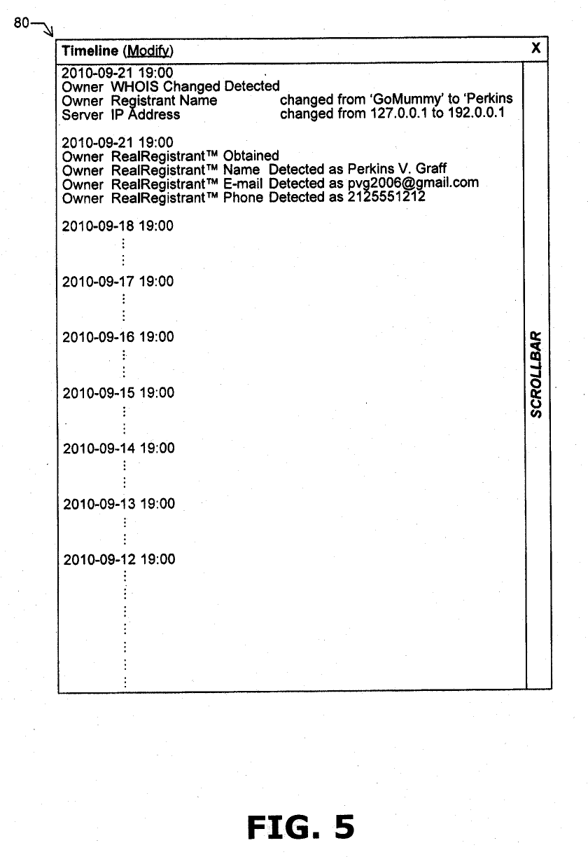

FIG. 5 is a representation of a timeline viewport 80 connected with a timeline scroller, according to one embodiment of the present invention. The timeline viewport 80 allows the user to view major changes that have occurred for a specific domain name across multiple snapshots. The information contained in the snapshots is summarized for the user in the viewport 80. For example, a change in WHOIS data would typically be collected as a major change. Other events may be designated as major events by the system and/or directly by the user.

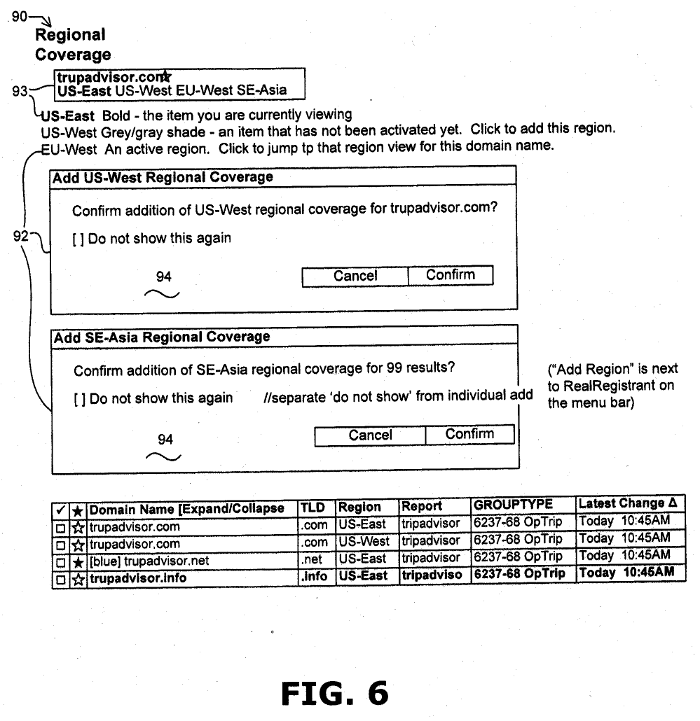

FIG. 6 is a pictorial illustration of an interface 90 for selecting one or more regions 92 from which to request information pertaining to a domain name of interest, according to one embodiment. As will be appreciated, any user accessing a domain may receive different information in response to the same request made in different regions. Thus, there can be varying information presented on a domain website depending on the origin of the user/request. The domain name of interest in FIG. 6 is ‘trupadvisor.com’. The available regions from which to request information are US-East, US-West, EU-West, and SE Asia. The currently viewed region is US-East 93, which is shown in bold. EU-West is also activated. The regions that have not been activated yet (US-West and SE Asia) are in gray shade. The user may activate a region by selection, e.g., by clicking on an active region causes the interface to jump to the view of that region for the domain name of interest. When the user clicks on a region that has not been activated, a dialog box 94 appears that prompts the user to add regional coverage for that region for the domain name of interest. As will be appreciated, any number of regions can be available for access through the interface 90.

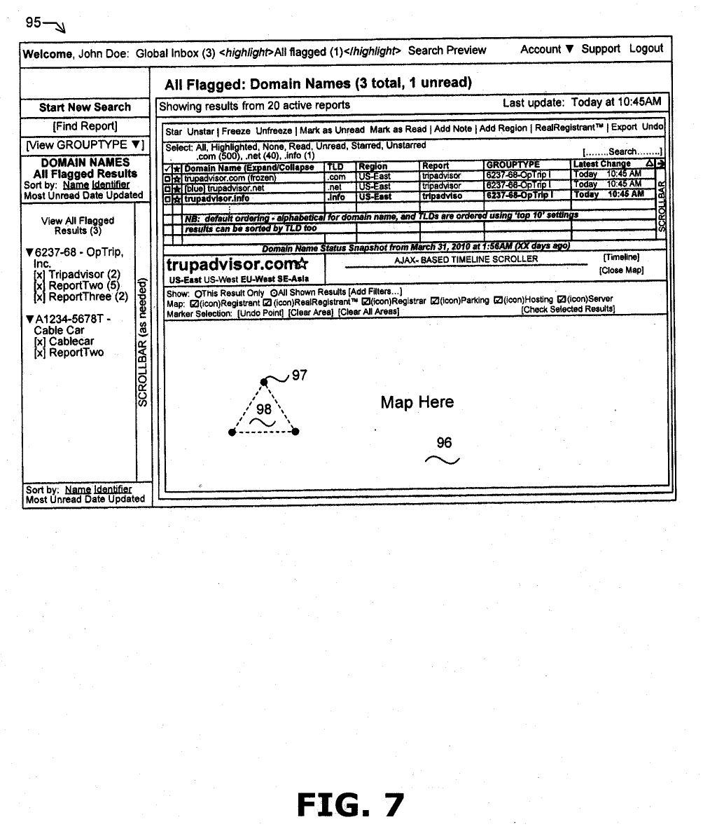

FIG. 7 is a pictorial illustration of a view map interface 95, which allows a user to specify a geographical region of interest by marking a map 96, according to one embodiment of the present invention. Domain names of interest that are registered in the region of interest are highlighted in the map 96 and in the list of domain names of interest. For example, the user marks the map 96 by clicking anywhere in the map to create a point 97. When the user has created three points, a triangular region 98 having those three points as vertices is thereby defined as the geographic region of interest. Of course, any variety of regions, sub-regions, and shapes can be utilized to define geographic areas of interest.

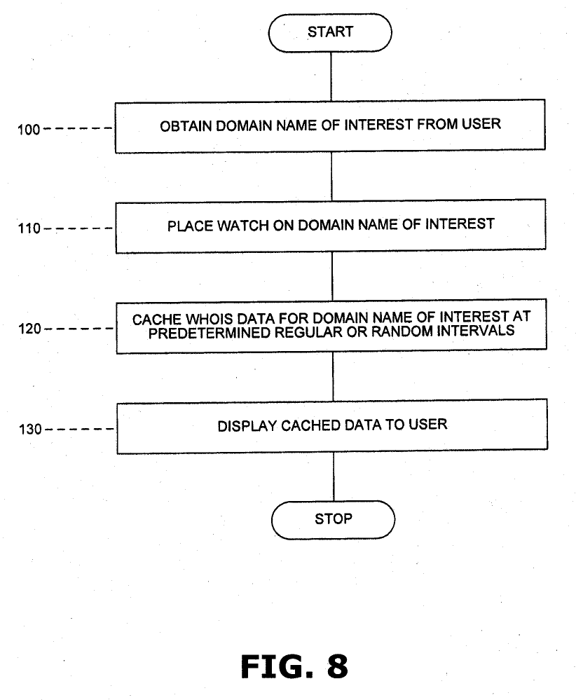

FIG. 8 is a flow chart of one possible method for generating the cache of information, e.g., as described previously in connection with FIG. 2. The method obtains a domain name of interest from a user (100), places a watch on that domain name (110), caches data for that domain name at certain intervals (120), and displays or otherwise provides the cached data to the user (130). The domain of interest from 100 can be determined in any suitable way. For example, the domain of interest may be explicitly defined by the user, selected by the system, and/or selected by the user after being provided similarity information by the system. The certain intervals of caching may be, e.g., at set periodic intervals, at random intervals, upon the occurrence of major events, or any combination thereof.

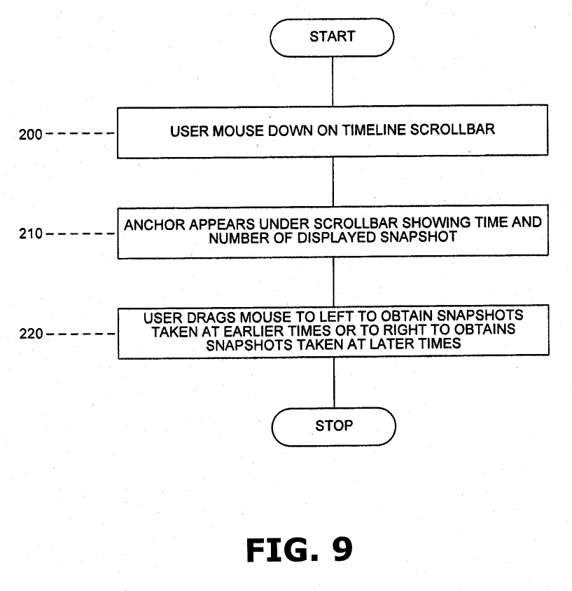

FIG. 9 is a flow chart detailing the behavior of a timeline scrollbar, such as the scrollbar described previously in connection with FIG. 4, when used in conjunction with a mouse. The user places mouse down on the timeline scrollbar (200), and an anchor appears under the scrollbar showing the time and number of the displayed snapshot (210). The user can drag the mouse to the left to view snapshots taken at previous times or to the right to view snapshots taken at later times (220). As will be appreciated, any point and/or other selection mechanism can be utilized depending upon the desired implementation.

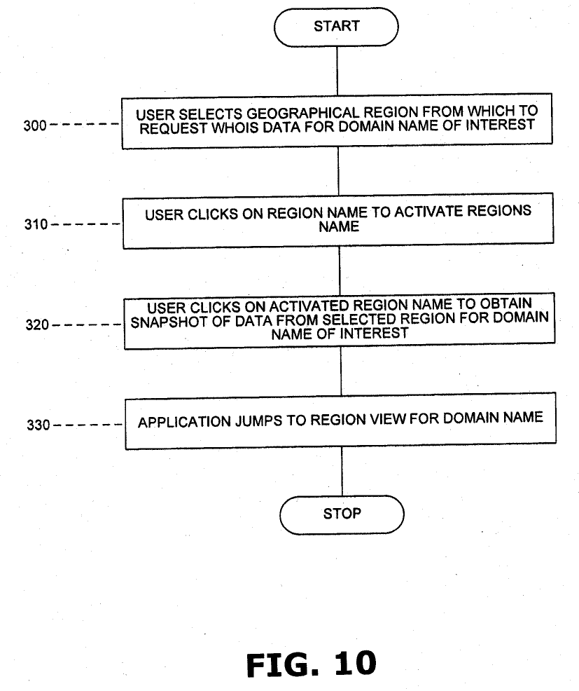

FIG. 10 is a flow chart detailing selection of a geographical region from which to request data pertaining to a domain name of interest, e.g., as described previously in connection with FIG. 6. At 300, a user selects a geographical region from which to request data. The geographical regions available can be predefined, or user created. At 310, the user clicks on the name of the region to activate the region name. At 320, the user selects the activated name to obtain a snapshot of data as such data is presented in response to a request made in the selected geographical region. At 320, the application displays the requested data to the user.

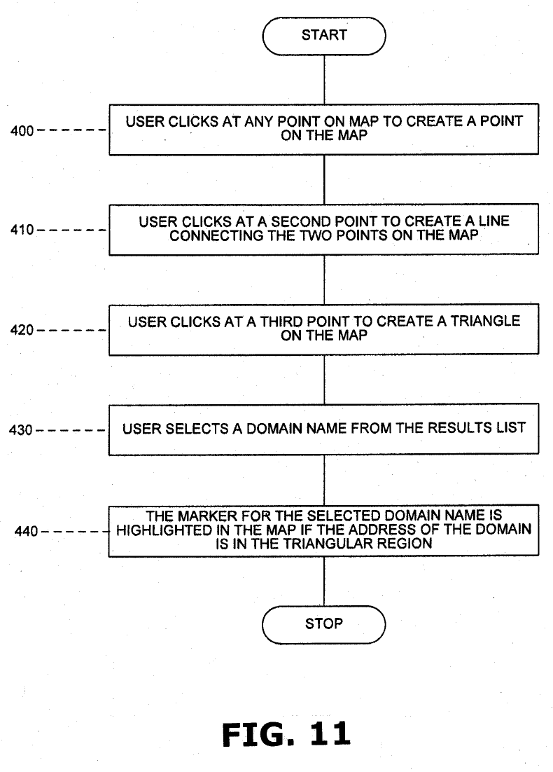

FIG. 11 is a flow chart detailing the specification of a geographical region of interest on a map, similar to that described previously in connection with FIG. 7. In this specific embodiment, the user defines a region on the map by clicking points on the map. At 400, the user clicks at any point on the map to create the first point. At 410, the user clicks at a second point to create a line. At 420, the user clicks at a third point to create a triangular region on the map. At 430, the user then selects a domain name from a results list. At 440, if the address of the domain name lies within the triangular region defined in 420, the marker for the domain name is highlighted in the triangular region in the map.

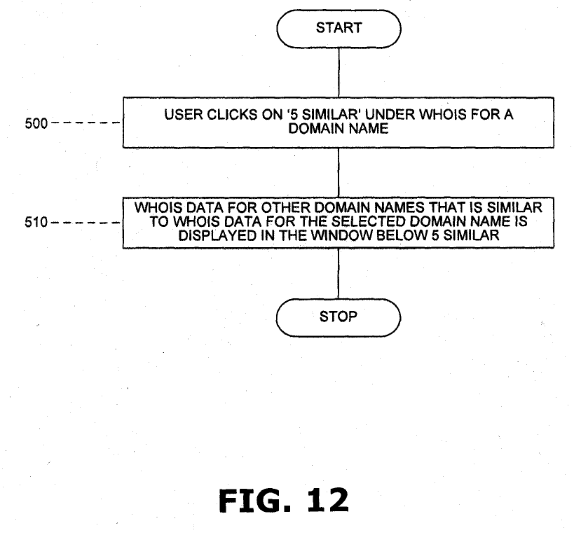

FIG. 12 is a flow chart detailing the collection of WHOIS data that is similar to the WHOIS data for a domain name of interest described previously in connection with FIG. 3. To display the similar data, the user clicks on ‘5 similar’ under WHOIS for the domain name of interest (500). WHOIS data for other domain names that is similar to the WHOIS data for the domain name of interest is displayed in the window below ‘5 similar’ (510).

### Tracking and Enforcing a User's Trademark Rights Against Infringing Parties

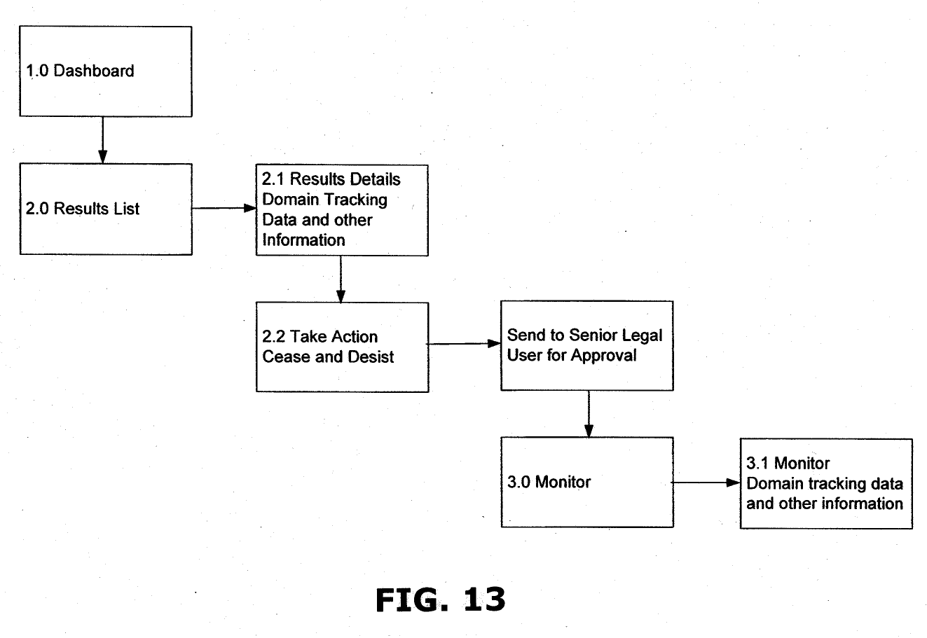

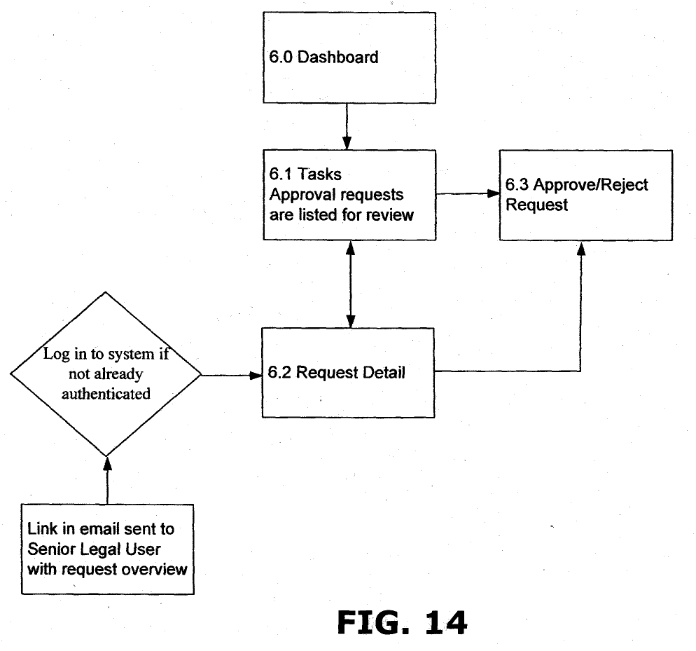

FIGS. 13 and 14 now illustrate an exemplary setup offered by a trademark enforcement service as introduced in this application. The trademark enforcement service (or simply, “trademark service”) may be used by a person or a company to track and identify various parties that are either competing or potentially infringing the trademark rights of the person or company. In one embodiment, the trademark service offers a dashboard that offers a user the capability to monitor infringing uses of the user's marks and related domain names. Using the dashboard, the user can determine appropriate courses of action (e.g., purchase, initiate cease & desist letters, etc.) with regard to the infringing entities.

In another embodiment, as illustrated in FIGS. 13 and 14, the trademark service offers users of the trademark service with different levels of privilege; where, for example, only a senior user of the service might have the privilege to approve an action through the trademark service while a junior user might be limited to suggesting a course of action to the senior user. Such an embodiment would reflect the nature of work-place hierarchy in most organizations that utilize the trademark service, where the different levels of privilege prevents a user from engaging in functions outside their scope of duty.

For example, FIG. 13 illustrates the functions performed by a junior user, where the junior user uses the trademark service to search for infringing uses of the user's marks, monitor the identified infringing uses of the user's marks, and suggest appropriate courses of action (e.g., purchase, initiate cease & desist letters, etc.) with regard to the infringing entities to a senior user. FIG. 14 illustrates the functions performed by a senior user, where the senior user, in addition to being able to perform all the functions of the junior user, has the additional responsibility of reviewing the suggestions of the junior user and either accepting or rejecting the suggested courses of action.

FIG. 13 is an illustrative block diagram explaining the various related functions performed by a junior user using the trademark service. An exemplary junior user of the trademark service could be an in-house associate working on trademark enforcement for a large corporate entity with a multitude of trademarks to be protected. The associate could log into the website of a trademark service provider using a personal user account to view her personalized Dashboard 1.0. The Dashboard 1.0 will present the associate with new, potentially infringing, domain names, identified by the trademark service, for a number of the trademarks the associate is responsible for. The associate could then click on one of the trademarks the associate is responsible for in the Dashboard 1.0 and open a new Results List 2.0 page. The Results List 2.0 page provides the associate with the list of all the infringing domain names identified by the trademark service for the selected trademark. The associate can quickly scan the result patterns in the Results List 2.0 and might decide to drilldown on one set of results for a detailed analysis of the possible infringement by a given domain name. The associate can click on one of the listing in the Results List 2.0 page to pull up a Results Details 2.1 page that provides the associate with information such as screenshots of the selected domain name.

Based on the detailed analysis of the possible infringement in the selected domain name, the associate can initiate an action against the selected domain name by using the Take Action 2.2 page. In another embodiment, the associate can skip the detailed analysis and initiate an action against the selected domain name from the Results List 2.0 page. The associate can use the Take Action 2.2 page to initiate, for example, a cease and desist action against the selected domain name with possible infringement issues. In accordance with various embodiments, the system can automatically generate the cease and desist letters based on target name, nature of infringement, and other selections. The system can include attachments (e.g., the screenshots of each domain) providing the necessary support and documentation for the letter.

Any action initiated by the associate is then forwarded to a senior associate or other supervising attorneys, who then either approves or rejects the associate's initiated course of action. The approval request, in some instances, can be forwarded as an email link, which the supervising attorney could utilize to either approve or reject the initiated course of action. In the meantime, the associate can continue monitoring the offending domain name and the status of the approval request through Monitor pages 3.0 and 3.1. The trademark service will indicate through Monitor pages 3.0 and 3.1, for example, whether any cases need further input to initiate action.

FIG. 14 is an illustrative block diagram explaining the various related functions performed by a senior user using the trademark service. An exemplary senior user of the trademark service could be an in-house senior attorney supervising the trademark enforcement work of an associate using the trademark service. The senior attorney could log into the website of a trademark service provider using a personal user account to view her personalized Dashboard 6.0. The Dashboard 6.0 will present the senior attorney with new, potentially infringing, domain names, identified by the trademark service, for a number of the trademarks the senior attorney is responsible for in addition to providing notifications for pending approval requests. The senior attorney could click on the pending Task Approval requests 6.1 page to review a list of enforcement actions, initiated by an associate, requiring her approval before further steps are taken. The senior attorney could approve or reject the enforcement actions at the Approve/Reject Request 6.3 page. Also, the senior attorney could request details of each task before approving the related enforcement action by utilizing the Request Detail 6.2 page. Once the senior attorney has reviewed the details pertaining to the enforcement action, the senior attorney can again use the Approve/Reject Request 6.3 page to either approve or reject the request. In another instance, the senior attorney could click on an email link, which might require logging into the trademark service website, to approve requests from an associate by performing the same review and approve/reject process.

### Junior User Using the Trademark Service

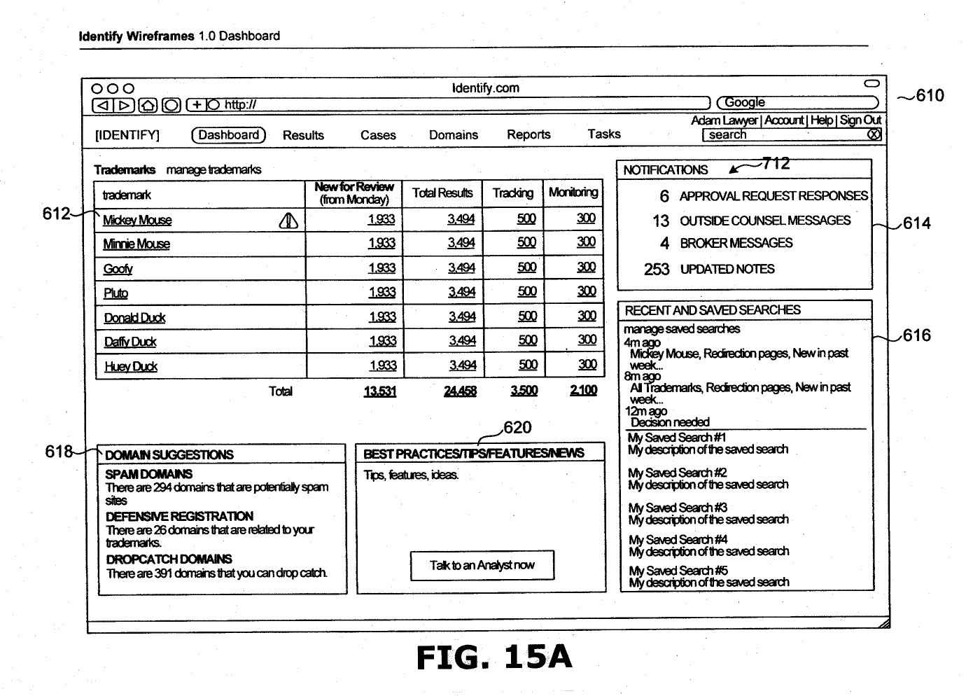

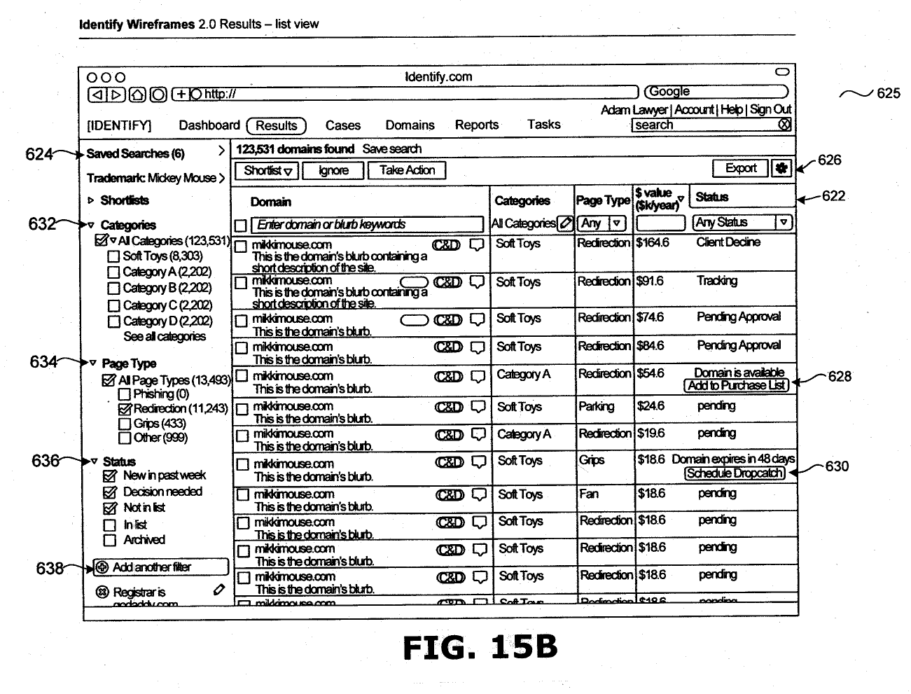

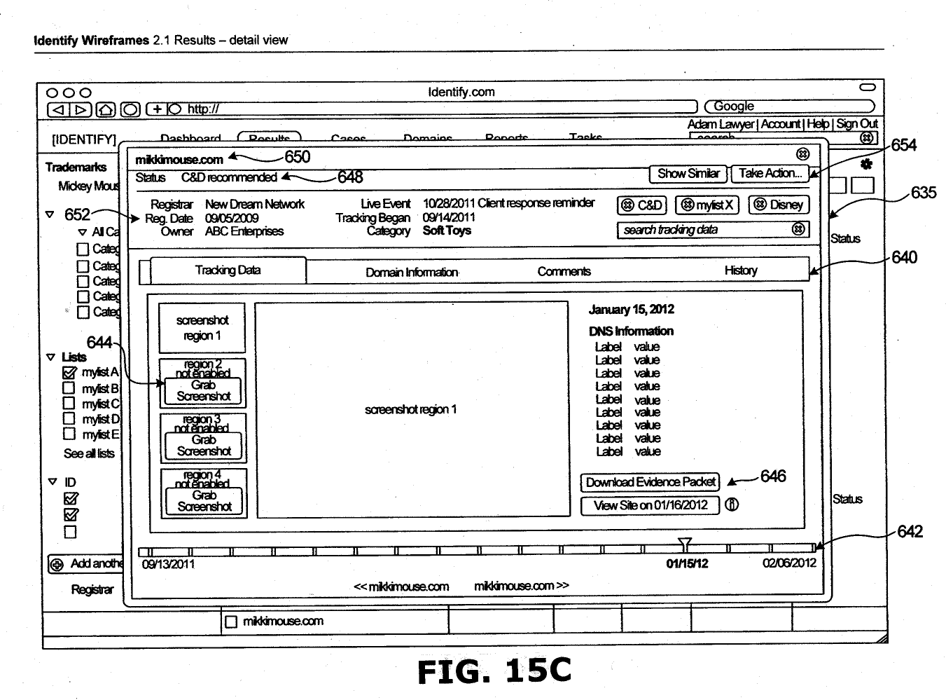

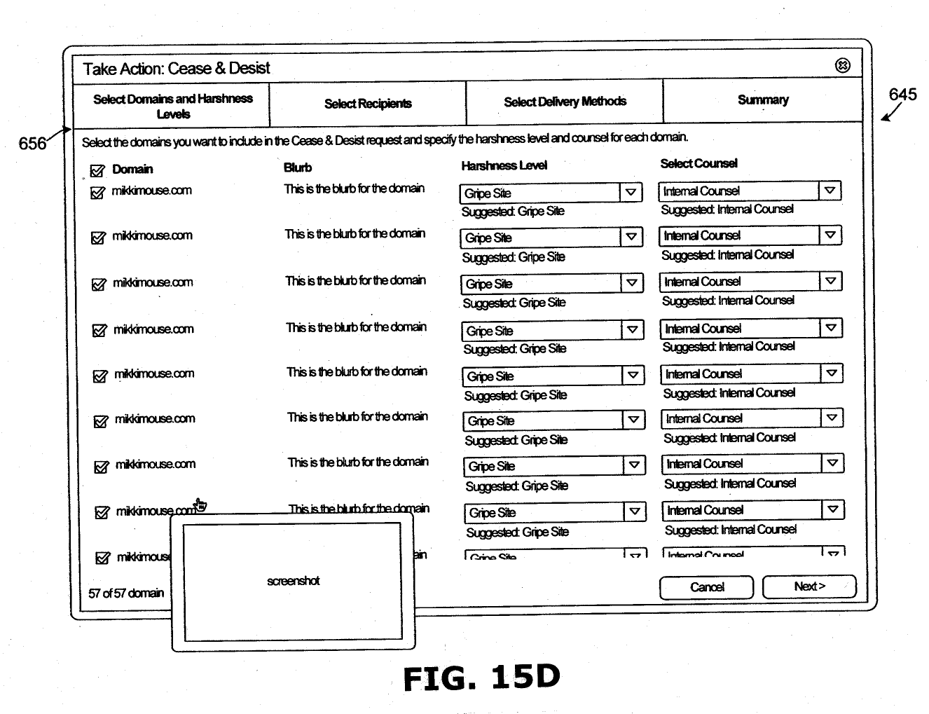

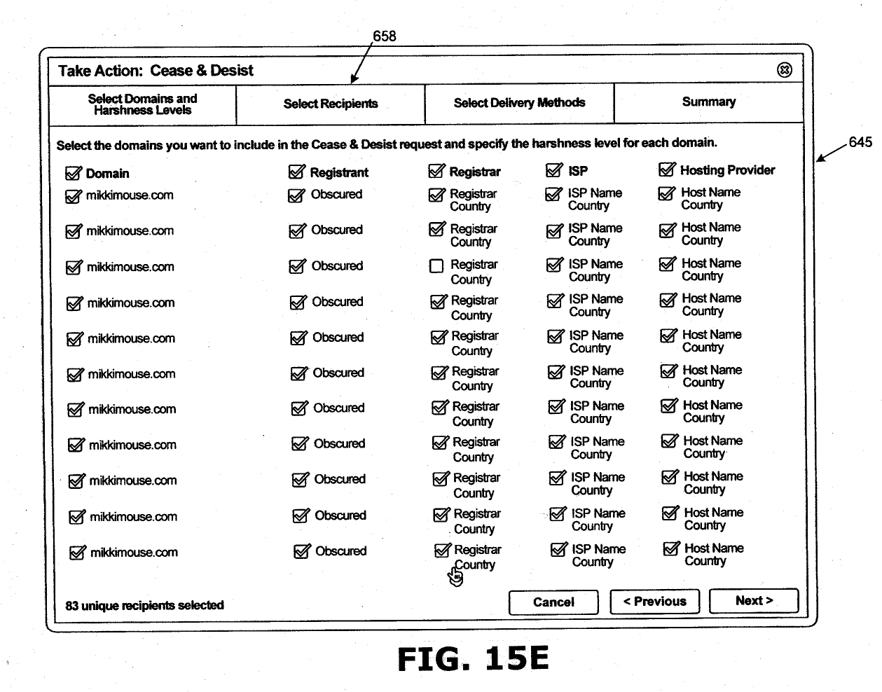

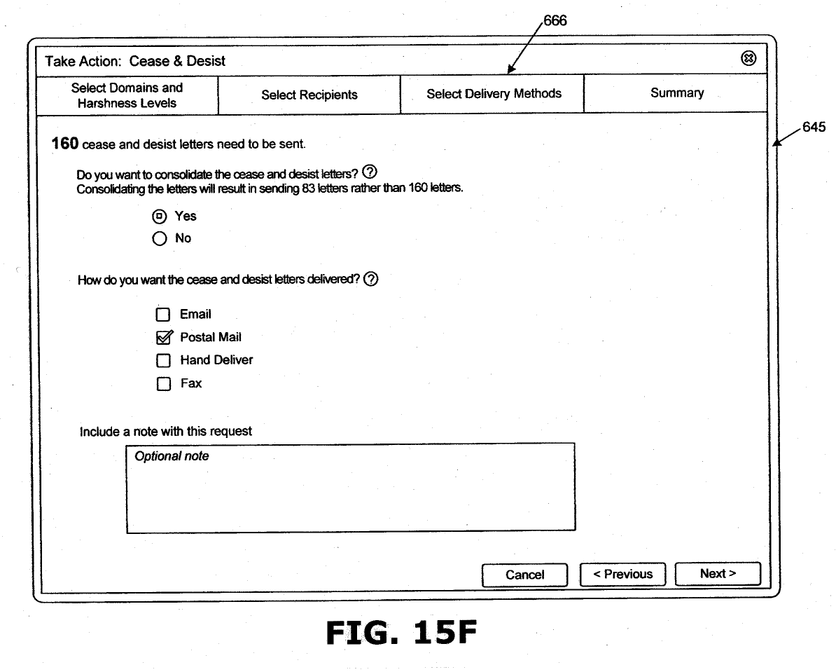

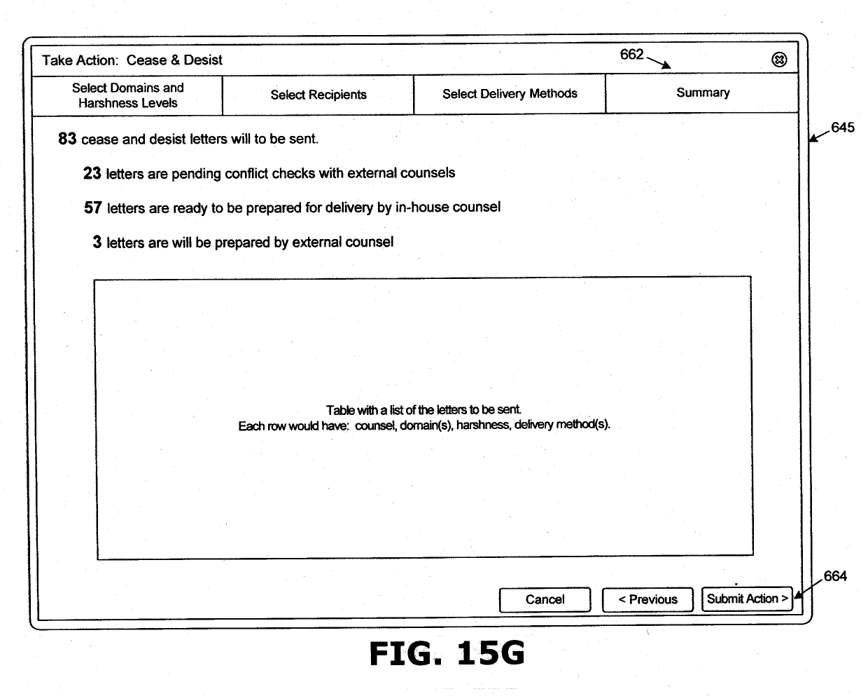

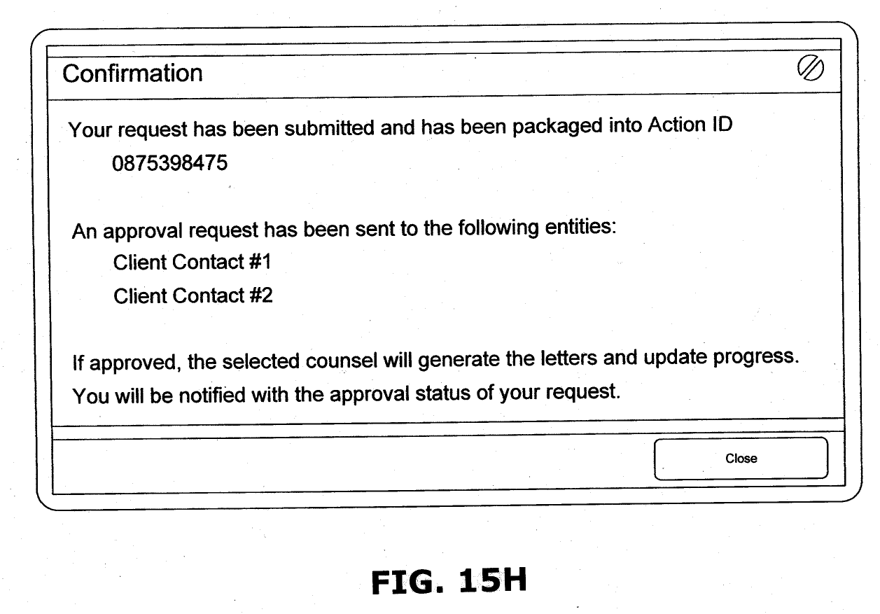

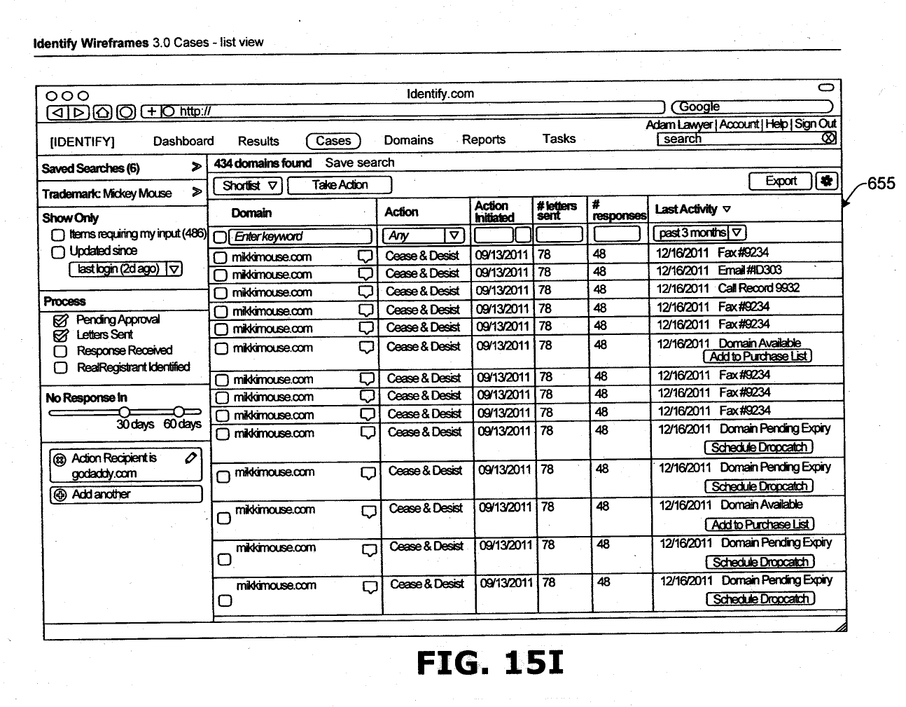

FIGS. 15A to 15I now illustrate an exemplary setup offered by a trademark enforcement service for a junior user (as described above with reference to FIG. 13) as introduced in this application. The trademark enforcement service (or simply, “trademark service”) may be used by a person or a company to track and identify various parties that are either competing or potentially infringing the trademark rights of the person or company. In one embodiment, as illustrated with reference to FIG. 13, the trademark service offers a dashboard that offers a user the capability to search for infringing marks, monitor such identified competing marks and suggest appropriate courses of action (e.g., purchase, initiate cease & desist letters, etc.) with regard to the infringing entities.

### Dashboard

FIG. 15A illustrates an example of an enforcement dashboard offered by the trademark service. It is understood that the illustration of FIG. 6A and all ensuing figures are for the purpose of exemplary illustration only, and that other variations and designs offering the information, as may be contemplated by a person of ordinary skill in the art, are also considered equivalent variations of the techniques presented herein. The dashboard 610 may be offered as personal software that can be installed in a user's computer, or may be simply offered as an online page via the Internet. In either scenario, the dashboard 610 tracks infringing uses of the user's trademarks with relation to a primary trademark identified by the user. In the example of FIG. 15A, Walk Disney, Inc. is the user using the dashboard service. The user wishes to identify and track all infringing uses of the user's trademark.

The dashboard presented in FIG. 15A is an overall setup offering a quick glance of the status of the user's options. For example, a first listing 612 includes a list of all trademark names owned by the user's entity. For example, Mickey Mouse, Minnie Mouse, etc. are the trademarks the current user intends to survey and monitor. The first listing 612 has several identifiers. A first identifier “New for Review” informs the user the number of infringing trademark usages recorded and identified by the trademark service since the last time the user visited the dashboard (in this example, since last Monday). Also, further details could be associated with each of the trademark names on the list to highlight certain flagged uses of the user's trademark when found. One such use could be the use of the user's trademark in phishing websites, where phishing websites utilize domain names closely associated with the user's trademark rights to masquerade as the user's entity.

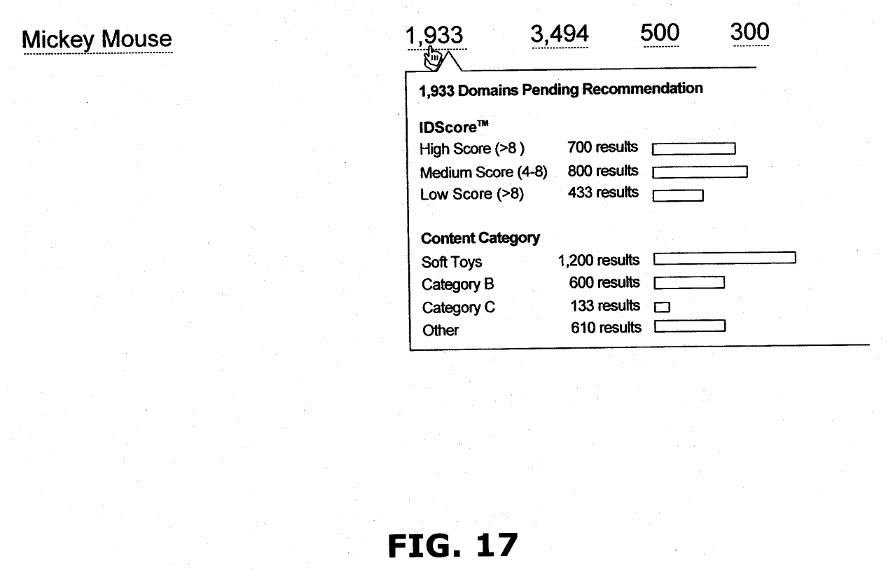

Additionally, the user could, in some instances, hover over the displayed number under the “New for Review” to get a detailed breakdown of the newly identified infringing domain names as shown in FIG. 17. The newly identified infringing domain names could further be broken down according to an IDScore assigned by the trademark service. The IDScore indicates the degree of the offending use as practiced by the newly identified infringing domain name. The degree of offending use is calculated based on various factors, such as the degree of similarity between the offending trademark use and the user's trademark, the quantified confusion in visitors to the offending domain name, the overall visitor traffic to the offending domain name, yearly revenue earned by the publisher of the offending domain name, etc.

In the example, the various procedures for trawling and identifying equivalent registrations or usage may be performed using general trawling and searching methodologies discussed above. A second identifier “Total Results” informs the overall total of the number of infringing trademark usages recorded and identified by the trademark service since the first time the user initiated the search through the dashboard. A third identifier “Tracking” informs the user of the number of infringing trademark usages that are being tracked for pursing potential trademark enforcement actions, where evidence of infringing use is still being gathered and no enforcement action has been suggested or initiated. A fourth identifier “Monitoring” informs the user of the number of infringing trademark usages that are being tracked for ongoing violations of the user's protected trademark rights with an associated enforcement action pending resolution.

In the examples illustrated here, the infringing entities may be in the form of infringing trade names or domain names using phrases that are covered under the user's trademark rights. For the purpose of discussion, the infringing entities are illustrated here as domain names. Of course, it is understood that any infringing usage of the user's trademark rights may also be equally used in conjunction with the techniques discussed herein.

The dashboard presented in FIG. 15A also includes, for example, a second listing 614 that provides the user with notification relating to the tracking and monitoring of domain names using phrases that are covered under the user's trademark rights. The notifications could be, for example, related to messages from outside counsels pertaining to enforcement of user's trademark rights against infringing domain names. The notifications could further include approval requests to initiate action against infringing domain names, information about updates to notes relating to the various identified infringing domain names, etc.

The dashboard presented in FIG. 15A also includes, for example, a third listing 616 that provides user with a list of recent searches relating to the infringing domain names. The user can track and retrieve the results of the each search by clicking on the listing associated with each of the respective search. The dashboard presented in FIG. 15A further includes, for example, a fourth listing 618 that provides user with a list of suggestions pertaining to the user's trademark and the identified infringing domain names. The list of suggestions could include, for example, the number of identified domain names that are associated with spamming, the number of identified domain names that are closely related to the user's trademark, which are still unclaimed, etc.

By defensively registering such unclaimed, closely related domain names, the user can prevent future misuse of such closely related domain names. The list of suggestions could further include, for example, the number of identified domain names that are registered and closely related to the user's trademark, but are coming up for registration renewal. By tracking such closely related domain names, any such domain names that are not renewed in time by the current owner could be registered by the user to prevent future misuse of the closely related domain names. The dashboard presented in FIG. 15A also includes, for example, a fifth listing 620 that provides user with general information pertaining to practices, tips, news, etc. that are related to the services offered through the trademark service.

### Results Page

FIG. 15B illustrates an example of results page generated from search that was initiated through the dashboard 610 of the trademark service. It is understood that the illustration of FIG. 15B and all ensuing figures are for the purpose of exemplary illustration only, and that other variations and designs of offering the information, as may be contemplated by a person of ordinary skill in the art, are also considered equivalent variations of the techniques presented herein. The results page 625 may be offered as a page within a personal software that can be installed in a user's computer, or may be simply offered as an online page via the Internet. In either scenario, the results page 625 provides an overview of all the infringing trademark usage identified by the search, where the results in a results page 625 pertains to a particular trademark listed in the first listing 612 in the dashboard 610. For example, the results page 625 provides an overview of each of identified infringing trademark usages associated with Mickey Mouse, one of the listed trademarks in the first listing 612 in the dashboard 610.

The results page 625 presented in FIG. 15B includes a plurality of listings that provide details on the various infringing trademark usages, used as domain names, as identified by the search. For example, the first listing 622 in FIG. 15B provides details on the various infringing trademark usages identified in the contents of the various websites, each website listed under “Domain”, where the contents of the websites are evaluated for the use of the protected trademark, the number of references to the trademark, the nature of use of the trademark, etc. An analysis of the nature of user of the trademark could include whether the trademark reference is of a protected fair-use nature, such as a news site, or one relating to commercial exploitation of the mark, such as selling trademark related merchandise. Further, the identified references in the websites could be analyzed for relatedness to the protected mark. For example, Mickey Mouse trademark could be, for example, referenced in the website content as mikkimouse, mikkimous, etc., where the phrases mikkimouse and mikkimous, with appropriate separation between the two words that form the phrase, are closely related to the protected trademark Mickey Mouse.

In another embodiment, a first listing 622 in FIG. 15B provides details on the various infringing trademark usages used as domain names as identified by the search through several identifiers. The first listing 622 includes a first identifier “Domain”, where the first identifier lists various domain names that use phrases that are closely related to or covered under the user's trademark rights. The domain names related to the Mickey Mouse trademark could be, for example, mikkimouse.com, mikkimous.com, etc., where the phrases mikkimouse and mikkimous, with appropriate separation between the two words that form the phrase, are closely related to the protected trademark Mickey Mouse.

A second identifier “Content” in first listing 622 classifies the infringing trademark usages used as domain names (“offending domains”) according to the nature of any products transacted through such offending domain names. For example, in first listing 622, the offending domain name mikkimouse.com is classified under “Soft Toys” to identify the nature of products transacted through mikkimouse.com as relating to toys of a certain nature. In some instances, the user could define their own categories of classification to further customize the characterization of the identified offending domain name.

A third identifier “Page Type” in first listing 622 classifies the identified offending domain names according to any flagged actions associated with the offending domain names. For example, the offending domain names could be classified under phishing, when the trade mark service determines the domain name primarily serves as a phishing website to scam visitors to the website. Other classifications could include redirection, gripe, fan, etc. A fourth identifier “$ value ($k/year)” in first listing 622 reports any revenue earned the publishers of the offending domain names. The source of revenue could be revenue earned through placement of online ads, products sold, offer of unauthorized services related to user's entity, etc.

A fifth identifier “Status” in first listing 622 classifies the identified offending domain names according to various actions either initiated by the user or suggested by the trademark service pertaining to each of the identified offending domain names. For example, in FIG. 15B, a status of “Client Decline” can be used to indicate that the user wishes to not pursue any enforcement action against the identified offending domain name. A status of “Tracking” can be used to indicate that the trademark service is still in the process of gathering evidence of the flagged use of the trademark in the offending domain name. A status of “Pending Approval” can be used to indicate that the trademark service is waiting for the approval of the user to initiate possible enforcement actions against the offending domain name.

In addition, a status of “Domain name is available” with an “Add to Purchase list” button 628 can be used to indicate to the user that the offending domain name has not been claimed by any entity and that by clicking the button 628 the user can initiate actions to purchase and claim the offending domain name. In one instance, the unclaimed offending domain name could be added to a list of domain names to be purchased by the user after further user review of the list. By giving users the option to purchase such offending domain names, the trademark service helps users prevent future misuse of the offending domain names.

Further, a status of “Domain name expires in x days” with a “Schedule Dropcatch” button 630 can be used to indicate to the user that the offending domain name is up for registration renewal in x days. Also, the user by clicking the button 630 can initiate actions to purchase and claim the offending domain name in the event the current owner of the offending domain name fails to renew the registration of the domain name.

The results page 625 presented in FIG. 15B includes a second listing 624 that provides user with option to retrieve results of previous searches through the “Saved Searches” tab. The second listing 624 further provides user with option to filter the results of the search for the offending domain names, which were provided in the first listing 622. Some of the options to filter the results are provided in FIG. 15B through 632, 634, 636 and 638. In one embodiment, the various filter options listed in FIG. 15B through 632, 634, 636 and 638 are generated by the trademark service by analyzing the first listing 622 that provides details on the various infringing trademark usages. Further, by analyzing the content of each website associated with the listed domain name, the system identifies the nature of website and the related infringing use of the trademark in the website. For example, the system analyzes the contents of the various websites associated with the listed domain names and creates categories such as “Soft Toys”, “Digital Media”, etc. The categories identify and categorize websites into those that are related to merchandizing soft toys, those that are related to selling digital content, etc. Similarly, the system analyzes the contents of the various websites associated with the listed domain names and generates page types for each of the website. Such page types could include “News”, “Phishing”, etc., where the types are used to identify and sort websites into those that are related to fair-use such as informative news reports, those that are related to websites used for scamming visitors, etc.

The results page 625 presented in FIG. 15B includes a third listing 626 that provides user with option to further categorize the offending domain names identified through the search. The user can “Shortlist” a selected domain name from the first listing 622 for further review and evaluation of possible enforcement action. In one embodiment, the system analyzes the user created “Shortlist” and determines common characteristics that the user is utilizing to “Shortlist” domain names from the general list of offending domain names identified through the search. The system then utilizes the determined common characteristics to further analyze the remaining offending domain names that have not been included by the user into the “Shortlist” and identifies domain names that share the determined common characteristics. In one embodiment, the system prompts the user with suggestion to include the offending domain names that were identified by the system using the common characteristics analysis.

In another embodiment, the user can “Ignore” or “Whitelist” a selected domain name from the first listing 622 to remove the selected domain name from the list of offending domain names as listed in first listing 622. In some instances, the trademark service can use the “Whitelist” to stop flagging domain names listed in the “Whitelist”. In one embodiment, the trademark service periodically analyzes the “Whitelist” to remove domain names that have been included in the list. The trademark service utilizes various criteria to determine whether a domain name that was previously removed from the offending domain name lists is now being used in an offending manner, such that the user needs to reevaluate the status of the domain name in the “Whitelist”.

In one instance, the criteria utilized by the trademark service to remove a domain name from the “Whitelist” could include criteria such as increase in page count in the given domain name, a sudden use of flash based content, a sudden increase of size of content in the given domain name, any incorporation of logo in the given domain name, any sudden changes in colors and composition of the web pages associated with the given domain name, any related redirection from the given domain name, change in DNS of the domain name, changes in the domain information tracked from the WHOIS database, such as ownership, registrar, etc. Further criteria could include change in IP address of the given domain name, change in the usage of redirection from the given domain name, use of relevant keywords, etc.

Further, in some instances, the user can be provided with the option to edit the “Whitelist” to add or remove domain names as necessary, where the “Whitelist” acts as an additional filter for future searches. The user can “Take Action” to perform an action on selected domain names from first listing 622, where, “Shortlist” adds the selected domain names to an existing shortlist, or create new shortlists in a user-related account section. Further, a “Whitelist” action removes the domain name from future views of results page 625 unless the user wishes to include the “Whitelisted” items in the results page. Additionally, a “Submit Recommendation” action could bring up a dialog box with a list of recommendations to attach to a selected domain name in the first listing 622.

### Detail Page

FIG. 15C illustrates an example of a detail page 635 provided by the trademark service when the user chooses to review an offending domain name listed in the first listing 622 in FIG. 15B. The detail page is served when the user, for instance, clicks on an offending domain name listed in the first listing 622 in FIG. 15B. For example, when the user clicks on the first domain name listing of mikkimouse.com in first listing 622 in FIG. 15B, the user is provided a detail page 635 associated with the domain name mikkimouse.com 650. It is understood that the illustration of FIG. 15C and all ensuing figures are for the purpose of exemplary illustration only, and that other variations and designs of offering the information, as may be contemplated by a person of ordinary skill in the art, are also considered equivalent variations of the techniques presented herein. The detail page 635 may be offered as a page within personal software that can be installed in a user's computer, or may be simply offered as an online page via the Internet.

The detail page 635 presented in FIG. 15C includes a plurality of listings that provide detailed information about the selected offending domain name 650. For example, a first listing 650 in FIG. 15C provides detailed information about the selected offending domain name 650. The first listing 640 includes a first identifier “Tracking Data”, where the first identifier includes information gathered about the offending domain name 650 after a user's election to track a domain name. In another instance, the tracking and gathering of details about a domain name could be automatically performed by the trademark service based on criteria such as auto-tracking domain names when the domain's IDScore is over a certain pre-determined threshold.

The first identifier “Tracking Data” could include information and statistics, such as, number of instances the user's trademark has been cited in the offending domain name 650, the yearly revenue associated with the offending domain name 650, visitor traffic data of the offending domain name 650, screenshots of any web pages in the offending domain name 650 that contain references to the user's trademark, etc. In some instances, the screenshots could be set to capture different regions of the offending domain name 650, where screenshots of regions not already captured can be added to the capture list by clicking “Grab Screenshot” 644 button. Each of the “Grab Screenshot” 644 button in FIG. 15C can be associated with a region of the web page, which when enabled, captures a screenshot of the region of the web page associated with that given “Grab Screenshot” 644 button. Further, in some instances, the screenshots are captured and displayed in the detail page 635 as a time-line 642, where each instance in the time-line 642 denotes a time-frame during which screenshots of the web page from the offending domain name 650 were taken. In FIG. 15C, for example, screenshots of web pages associated with offending domain name 650 mikkimouse.com was taken at Sep. 13, 2011, Jan. 15, 2012, Feb. 6, 2011, etc.

Further, the first listing 640 includes a second identifier “Domain name Information”, which includes information regarding registrars, registration date, owner contact information, etc. relating to the offending domain name 650. In addition, the first listing 640 includes a third identifier “Comments”, which includes comments relating to the offending domain name 650 made by other members of a team user is associated with, the number of new comments gathered since the user's last login, etc. The team could include other members from the user's entity who are also tasked with reviewing the results from the trademark search. The trademark service can collate all the comments from users associated with, for example, a given project, and categorize them according to the related offending domain name.

Also, the first listing 640 includes a fourth identifier “History”, which includes information such as, when the offending domain name 650 was added to a shortlist, who added the offending domain name 650 to the shortlist, any changes to the DNS information associated with the offending domain name 650, any changes to the offending domain's 650 status to, for example, “pending deletion”, any comments by other team members, any actions taken on the offending domain name 650 by other team members, etc.

In some instances, the detail page 635 presented in FIG. 15C further includes a second listing 652 that provide general information pertaining to the selected offending domain name 650, such as the registrar of the offending domain name 650, the date of the offending domain's 650 registration, the name of the current owner of the offending domain name 650, the start date of the offending domain's 650 tracking, the category the offending domain name 650 falls into, the date and time of the action that was carried out with respect to the offending domain name 650, etc.

In addition, in some instances, the user can hover over the information listed in second listing 652 for additional details pertaining to the listed information. For example, a user can hover over the information pertaining to the name of the current owner of the offending domain name 650 to retrieve additional information relating to the current owner, such as information about any additional offending domain names also owned by the same owner.

In some instances, the detail page 635 presented in FIG. 6C further includes a current status 648 associated with the offending domain name 650. The current status 648 could be the provided by the trademark service provider based on the gathered evidence relating to the offending domain name 650. For example, the trademark service provider can suggest “C&D recommended” as in FIG. 15C, where the suggestion pertains to sending the offending domain name 650 a cease and desist letter to prevent future misuse of the user's trademark rights.

In some instances, the user or a team member can set the current status 648 associated with the offending domain name 650, allowing other members in the team to pursue the recommendation if deemed appropriate by them. The detail page 635 further allows the user to initiate various actions pertaining to the offending domain name 650 through the “Take Action” button 654. In one instance, when the “Take Action” button 654 is clicked, the action to be taken would be based on the Status 648. In another instance, the user could be prompted with a list of actions to choose from. Some of the recommended actions could be, for example, adding the offending domain name 650 to shortlist for further review, marking the offending domain name 650 as an authorized reseller, suggesting negotiation with the current owner of offending domain name 650, proposing sending cease and desist letter to the offending domain's 650 owner, proposing initiating a lawsuit against the offending domain name 650, proposing arbitration to settle the matter, etc.

Based on the action initiated by the user, the trademark service allows the various evidence gathered about the offending domain's 650 use of a user's protected trademark to be downloaded and forwarded as needed through the “Download Evidence Packet” button 646. The evidence packet could include all the tracking data, domain name information, comments, history, general information, etc. pertaining to the offending domain name 650 as described above.

### Take Action Page

FIGS. 15D through 15G illustrates an example of take action page generated in response to an action initiated by the user pertaining to selected offending domain names. In one instance, the take action page can be initiated for pursuing a cease and desist action against offending domain names. Each cease and desist action could pertain either to a particular trademark owned by the user/user's entity or to a group of trademarks owned by the user/user's entity. For example, the take action can be initiated either through the “Take Action” button 626 in results page 625 or through the “Take Action” button 654 in details page 635. It is understood that the illustration of FIGS. 15D through 15G and all ensuing figures are for the purpose of exemplary illustration only, and that other variations and designs offering the information, as may be contemplated by a person of ordinary skill in the art, are also considered equivalent variations of the techniques presented herein. The take action page 645 may be offered as a page within personal software that can be installed in a user's computer, or may be simply offered as an online page via the Internet. In either scenario, the take action page 645 associated with a cease and desist (“C&D”) action provides the user with a list of domain names to pursue C&D action against, other relevant aspects to consider when initiating the C&D action, and an interface to initiate the C&D action.

The take action page 645 presented in FIGS. 15D through 15G includes a plurality of listings that provide an interface to initiate the C&D action against the offending domain names. For example, a first identifier “Select Domain names and Harshness Levels” 656 in FIG. 15D provides a user interface with detailed listing of all the offending domain names the user could purse C&D action against. The user interface could further include observations associated with each of the offending domain names in the form of blurbs, an associated harshness level at which to pursue the C&D action against each of the offending domain names, and information about the various counsels of the offending domain names who can be served with the C&D action.

In one embodiment, the user will be allowed to select/deselect and choose a subset of offending domain names from the list of domain names provided in the take action page 645. Further, the user will be allowed to choose the level of harshness for each of the selected offending domain names, where a choice of gripe site, fan site, unauthorized reseller site, etc. would entail a soft C&D enforcement. A soft C&D enforcement could be, for example, an action that provides the associated offending domain names up to two weeks to stop and remove any infringing use from the web pages associated with the offending domain names. Also, a choice of false affiliation, copyright infringement, improper competitor comparative advertising, phishing, etc. for the harshness level associated with the offending domain name could entail an aggressive C&D enforcement. For instance, the time period allowed for stopping and removing any infringing use from the web pages associated with the offending domain names could be reduced to one week. Further, any clear copyright violation or domain names associated with phishing could be immediately taken down by contacting the web host of the offending domain name in addition to sending a C&D letter to prevent future misuse. Also, the user can choose the counsel of the offending domain name who should be served with the C&D action.

In one embodiment, the take action page 645 presented in FIG. 15E includes a second identifier “Select Recipients” 658 associated with the take action page 645, which the user can navigate to after the user has taken any necessary action pertaining to the C&D action in the first identifier 656. However, it should be clear that any order of navigation presented in this embodiment between the different identifiers of the take action page 645 does not suggest that such an order is necessary to initiate an action through take action page 645. The order is merely stated for illustrative purposes and the user is not required to follow the described order to initiate action through the take action page 645. For instance, default values in each of the identifiers allow the user to interact with any of the interface without respect to any order of navigation in order to initiate an action.

The second identifier illustrates a part of the take action page's 645 user interface, where the user is provided with a select list of all the offending domain names the user chose to purse C&D action against in first identifier 656 interface, and the list of all the recipients associated with the offending domain names who should be served with the C&D action. The recipients could be, for example, the registrant of the offending domain name, the registrar of the offending domain name, the ISP of the offending domain name, the hosting provider of the offending domain name, etc.

In one embodiment, the take action page 645 presented in FIG. 6F includes a third identifier “Select Delivery Methods” 660 associated with the take action page 645, which the user can navigate to after the user has taken any necessary action pertaining to the C&D action in the second identifier 658. The third identifier illustrates a part of the take action page's 645 user interface, where the user is provided with options regarding deliver of the C&D letters, such as the mode of delivery of the C&D letters, whether to consolidate the C&D letters by, e.g., common owner of offending domain names, common registrant of offending domain names, etc. Further, the user could share notes with counsels who could be initiating action against the offending domain names at the behest of the user/user's entity. The notes could be included in the notes section of the third identifier 660, where the notes could be regarding objectives to pursue, cost limits, etc. In another embodiment, the take action page 645 presented in FIG. 15G includes a fourth identifier “Summary” 662 associated with the take action page 645, which the user can navigate to after the user has taken any necessary action pertaining to the C&D action in the third identifier 660.

The fourth identifier presented in FIG. 15G illustrates a part of the take action page's 645 user interface, where the user is provided with a status summary of the C&D actions initiated by the user. The summary could include the identity of the entity preparing the C&D letters, the status of the preparation of the C&D letters, information about any C&D letter preparation that is yet to be assigned to an entity for preparation, etc. In some instances, the user is provided with an option to submit the C&D action initiated through the take action page 645 with a “Submit Action” 664 button in the take action page 645. In one instance, the submission of the action could automatically forward any C&D action to the appropriate approver when such approval is needed from either, say, another team member or the client. FIG. 15H illustrates a confirmation summary that could be provided to the user when the user initiates a C&D action by clicking the “Submit Action” 664 button in the take action page 645.

### Cases Page

FIG. 15I illustrates an example of cases page 655 that summarizes the various actions initiated by the user against the various offending domain names and the current status of such actions. It is understood that the illustration of FIG. 15I and all ensuing figures are for the purpose of exemplary illustration only, and that other variations and designs of offering the information, as may be contemplated by a person of ordinary skill in the art, are also considered equivalent variations of the techniques presented herein. The cases page 655 may be offered as a page within personal software that can be installed in a user's computer, or may be simply offered as an online page via the Internet. In either scenario, the cases page 655 summarizes the various actions initiated by the user against the various offending domain names and the current status of such actions. For example, the cases page 655 provides an overview of the actions initiated by the user with respect to one of the user's trademarks, Mickey Mouse, and the status of each of the initiated actions.

The illustrative cases page 655 presented in FIG. 15I includes several identifiers. The various identifiers described below are found in the cases page as presented in FIG. 15I and are not to be confused with description of identifiers associated with other figures. A first identifier “Domain” in FIG. 15I lists the names of the various offending domain names against which the user has initiated actions, such as C&D, against. A second identifier “Action” in FIG. 15I lists the type of action initiated by the user against the listed offending domain names, such as the C&D action illustrated above in FIGS. 15D through 15H. A third identifier “Action Initiated” provides the date the action listed in second identifier was initiated.

The fourth identifier “#letters sent” shows the total number of letters sent in the course of the enforcement of the associated action, while the fifth identifier “# responses” shows the total number of letters received in response to the various letters sent as denoted in fourth identifier. The sixth identifier “Last Activity” shows the last event that was taken in association with the enforcement of the action identified in second identifier “Action”. The “Last Activity” could be, for example, date and time of any communication sent, etc. Further the identifier “Last Activity”, similar to the “Status” identifier in results page 625, allows the user to purchase offending domain names that are still unclaimed and those that might become available when the current owner fails to renew the registration of the offending domain name. The buttons “Add to Purchase list” and “Schedule Dropcatch” in Last Activity” perform functions similar to the alike buttons in “Status” identifier in results page 625.

### Senior User Using the Trademark Service

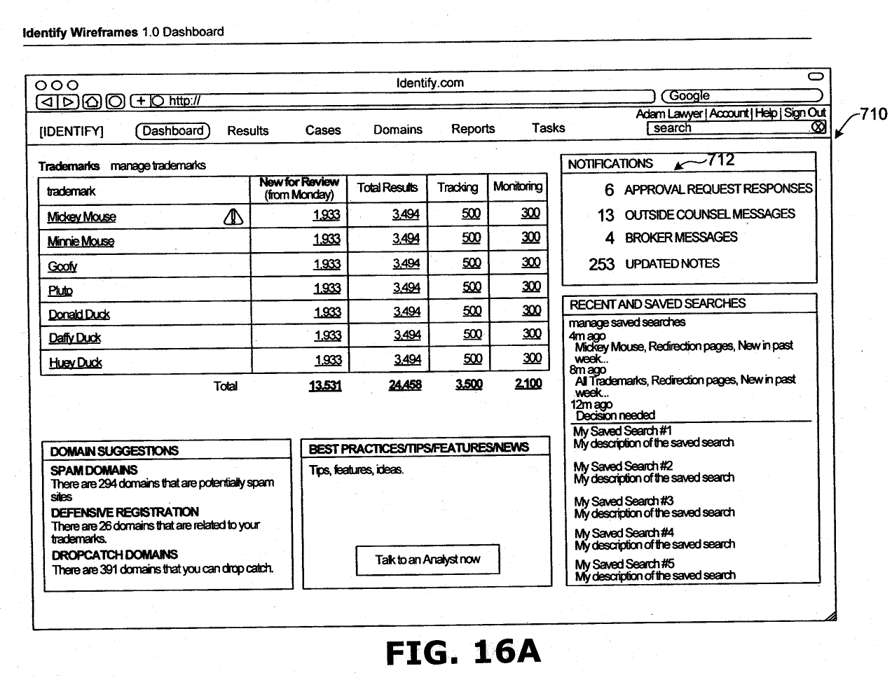

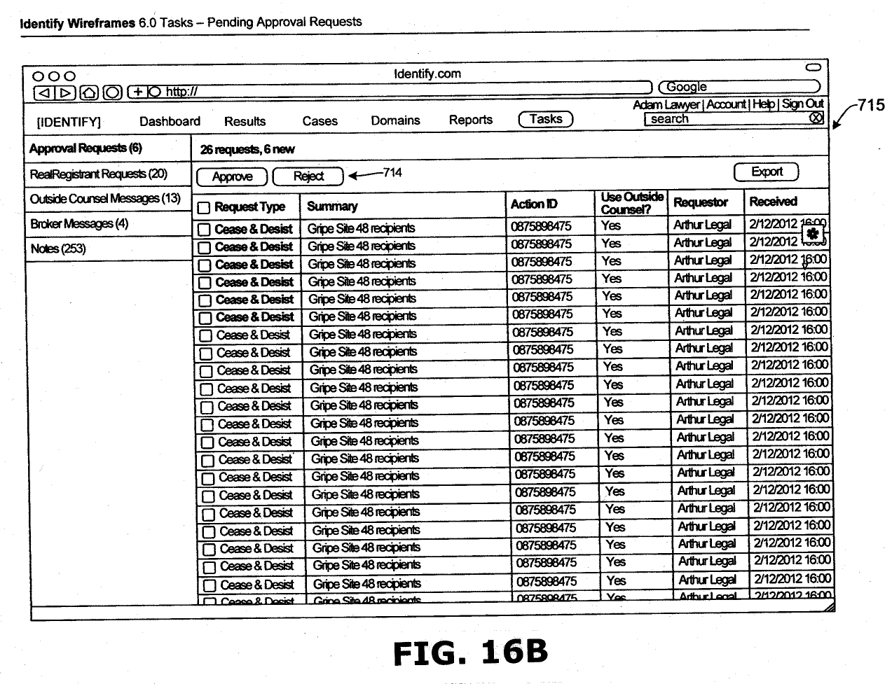

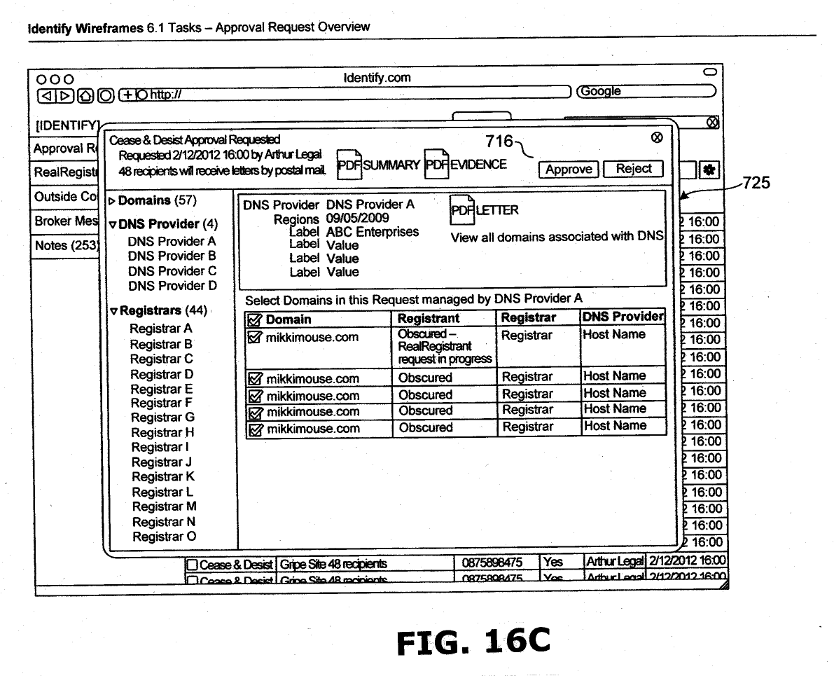

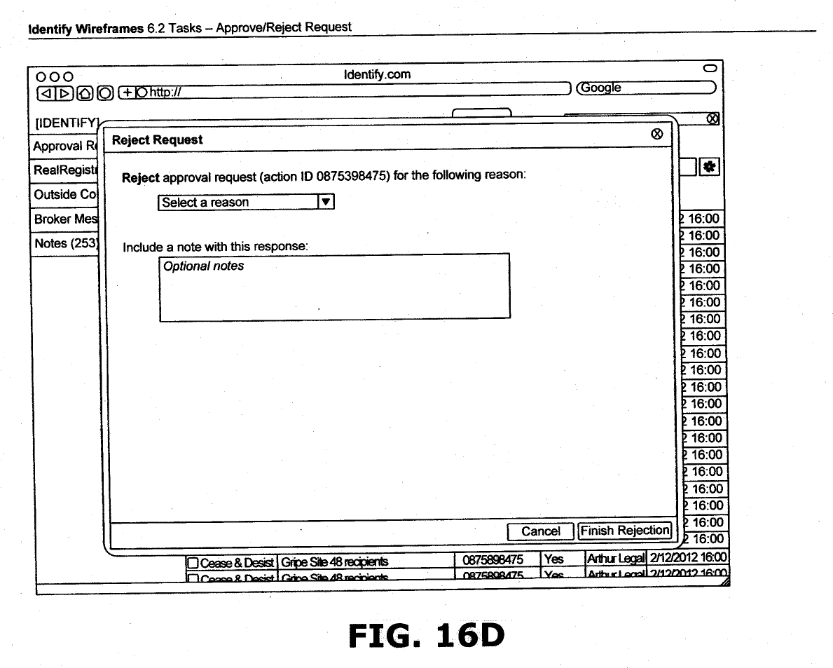

FIGS. 16A to 16D now illustrate an exemplary setup offered by a trademark enforcement service for a senior user (as described above with reference to FIG. 14) as introduced in this application. The trademark enforcement service (or simply, “trademark service”) may be used by a person or a company to track and identify various parties that are either competing or potentially infringing the trademark rights of the person or company. In one embodiment, as illustrated with reference to FIG. 14, the trademark service provides a dashboard that allows a senior user to not only perform all the functions of the junior user, but also allows the senior user to perform additional tasks such as reviewing the suggestions of the junior user, approving or rejecting such suggested courses of action, etc.

### Dashboard

FIG. 16A illustrates an example of an enforcement dashboard offered by the trademark service. It is understood that the illustration of FIG. 16A and all ensuing figures are for the purpose of exemplary illustration only, and that other variations and designs of offering the information, as may be contemplated by a person of ordinary skill in the art, are also considered equivalent variations of the techniques presented herein. The dashboard 710 may be offered as personal software that can be installed in a user's computer, or may be simply offered as an online page via the Internet. In either scenario, the dashboard 710 tracks infringing trademark usages with relation to a primary trademark identified by the user.

In one embodiment, the dashboard presented in FIG. 16A is functionally equivalent to the dashboard described with reference to FIG. 15A. For example, the dashboard 710 also provides a list of all trademark names owned by the user's entity. For example, Mickey Mouse, Minnie Mouse, etc. are the trademarks the current user intends to survey and monitor. The dashboard 710, similar to dashboard 610, includes several identifiers, such as “New for Review”, “Total Results”, “Tracking”, “Monitoring”, etc. For a full description of the various functionalities associated with the dashboard 710, refer above to the description of dashboard 610.

The dashboard presented in FIG. 16A also includes a listing “NOTIFICATIONS” 712 that provides user with notification relating to any initiated action pertaining to an offending domain name that uses phrases that are covered under the user's trademark rights. The notifications could be, for example, related to messages from outside counsels pertaining to enforcement of user's trademark rights against infringing domain names. The notifications could further include information pertaining to any pending approval requests to initiate action against offending domain names, etc. where the user could perform the approval requests in a different page independent of the dashboard 710.

### Tasks Page

FIG. 16B illustrates an example of tasks page 715 that lists the various approval requests that are pending approval by the user and provides an interface to approve or reject such approval pending requests. It is understood that the illustration of FIG. 16B and all ensuing figures are for the purpose of exemplary illustration only, and that other variations and designs of offering the information, as may be contemplated by a person of ordinary skill in the art, are also considered equivalent variations of the techniques presented herein. The tasks page 715 may be offered as a page within personal software that can be installed in a user's computer, or may be simply offered as an online page via the Internet. In either scenario, the tasks page 715 summarizes the various approval requests that are pending approval by the user and provides an interface to approve or reject such approval pending requests.

The illustrative tasks page 715 presented in FIG. 16B includes several identifiers. The various identifiers described below are found in the tasks page as presented in FIG. 16B and are not to be confused with description of identifiers associated with other figures. A first identifier “Request Type” in FIG. 16B lists the type of action, associated with each approval request, which is pending user's approval. For example, in FIG. 16B, the actions associated with each of the listed approval request is of action type Cease & Desist.

A second identifier “Summary” in FIG. 16B lists the nature of the domain name the pending action is initiated against and the number of recipients who will be served with the associated enforcement action. For example, in FIG. 16B, the nature of domain names flagged for action are of “Gripe” type while a total of 48 recipients have been identified to be served with a Cease and Desist letter. Further, a third identifier “Action ID” in FIG. 16B lists any alpha-numeric number assigned by the trademark service when the enforcement action was initiated, for example, by a junior user. Additionally, the tasks page 715 includes identifiers pertaining to information about the initiator of the enforcement action, the date the enforcement action was received by the user, etc.

The tasks page 715 further includes an “Accept” and “Reject” button 714 as shown in FIG. 16B. In some instances, the tasks page 715 allows the user to select enforcement actions listed in the tasks page 715 and either approve or reject those actions using the “Accept” and “Reject” button 714. An acceptance of the suggested enforcement action will initiate further actions, such as, requesting the trademark service to forward the gathered evidence and any cease and desist letter prepared to an identified counsel to send the cease and desist letter. On the other hand, a rejection of the suggested enforcement action will require the user to provide reasons for rejection and other information that might support the basis for rejection through a user interface such as the one illustrated in FIG. 16D.

### Detail Tasks Page

FIG. 16C illustrates an example of a detail tasks page 725, provided by the trademark service, shown when the user chooses to review the details of an enforcement action request before approving the action. The detail tasks page 725 is served when the user, for instance, clicks on any of the listed pending enforcement actions provided through the tasks page 715. For example, when the user clicks on a listing with Action ID 0875398475 in FIG. 16B, the user is provided a detail tasks page 725 associated with the Action ID 0875398475. In one instance, the detail tasks page 725 aggregates all the offending domain names associated with an entity into a single, for example, cease and desist action.

In one embodiment, the trademark service identifies the entity that is associated with the various offending domain names by utilizing the information gathered from a WHOIS query for each of the offending domain names, where the WHOIS query provides information such as a name of a registrant of the given domain name, a contact information of the registrant of the given domain name, a status of a registration of the given domain name, a date of the registration of the given domain name, a date of expiry of the registration of the given domain name, etc. In some embodiments, the trademark service analyzes not only the current information stored in the WHOIS associated database but also snapshots of the WHOIS record before any changes were made to the current information in the WHOIS associated database. The trademark service analyzes the commonality of information amongst the various domain names and scores the relatedness of each domain name to the other offending domain names in the list. For example, when two domain names share the same phone number and mailing address but have different registrants listed as owners, the two domain names are highly likely to be owned by the same entity but under different subsidiaries. In such instance, the trademark service could give the two domain names a high relatedness score and group the two domain names under the entity information of one of the domain names. Similar combination of other available information is possible to determine the relatedness of any given set of domain names to determine any commonality of ownership between the given set of domain names.

The detail tasks page 725 could further provide information regarding the name of the offending domain name, the registrant for the offending domain name, the registrar for the offending domain name, the DNS provider for the offending domain name, etc. The detail tasks page 725 could further include an “Accept” and “Reject” button 716 as shown in FIG. 16C. In some instances, the detail tasks page 725 allows the user to either approve or reject the enforcement actions against the entity owning the offending domain names using the “Accept” and “Reject” button 716. An acceptance of the suggested enforcement action will initiate further actions, such as, requesting the trademark service to forward the gathered evidence and any cease and desist letter prepared to an identified counsel to send the cease and desist letter. On the other hand, a rejection of the suggested enforcement action will require the user to provide reasons for rejection and other information that might support the basis for rejection through a user interface such as the one illustrated in FIG. 16D. It is understood that the illustration of FIG. 16C and all ensuing figures are for the purpose of exemplary illustration only, and that other variations and designs of offering the information, as may be contemplated by a person of ordinary skill in the art, are also considered equivalent variations of the techniques presented herein. The detail tasks page 725 may be offered as a page within personal software that can be installed in a user's computer, or may be simply offered as an online page via the Internet.

### Trademark Registration Service

Various embodiments of the present invention allow for end users, such as owners or in-house attorneys, to ensure that their trademarks and domain names are properly maintain and renewed. These systems and help prevent the potential of misuse by sophisticated entities which can take advantage of the failure to register even when such a window of failure constitutes an insignificant time to most users. In one embodiment, as part of the protection and enforcement service, the trademark service could provide users of the service with a safety-net to prevent such failed registration of trademarks, domain names, etc.

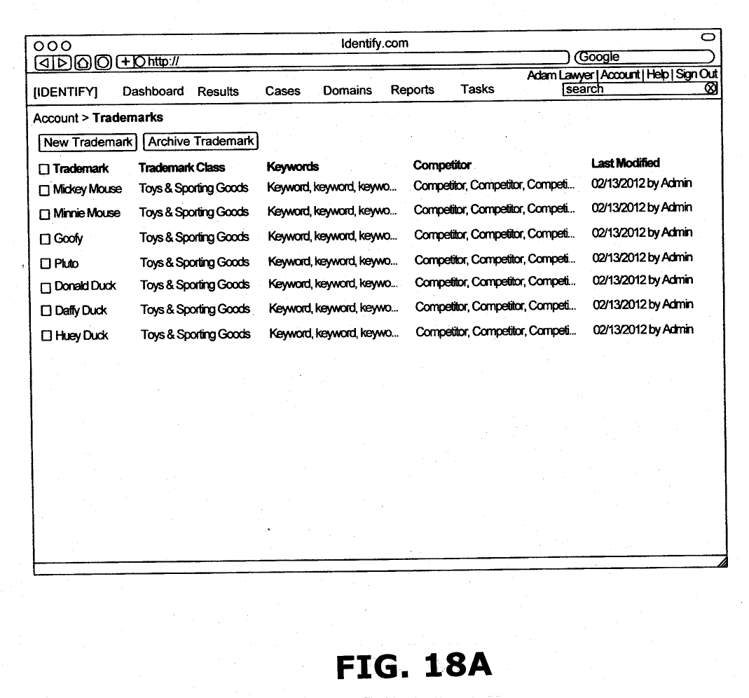

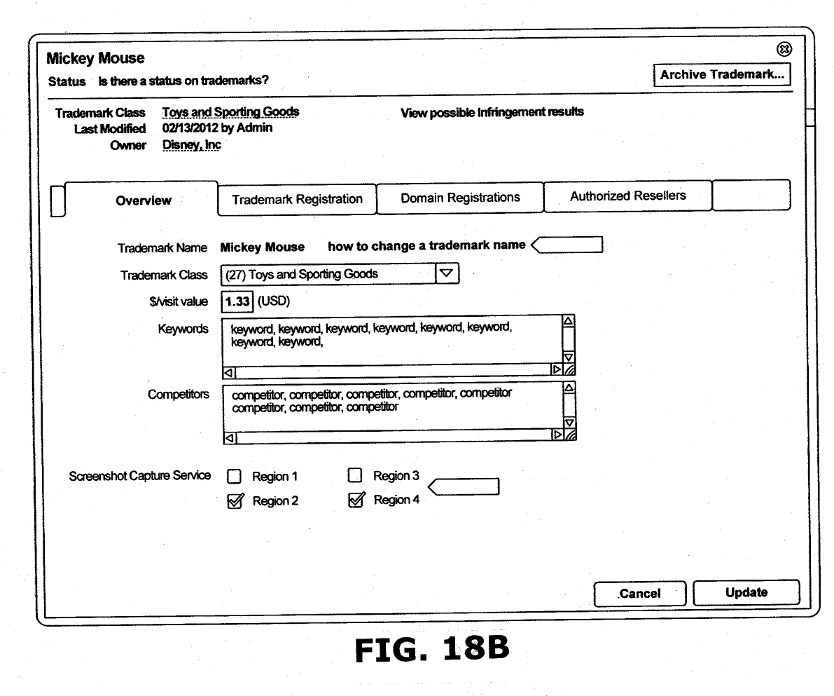

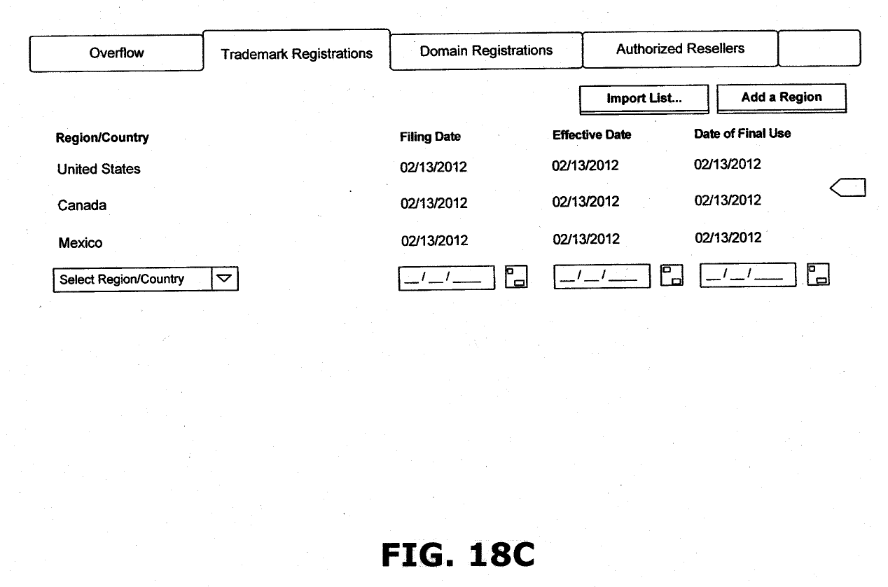

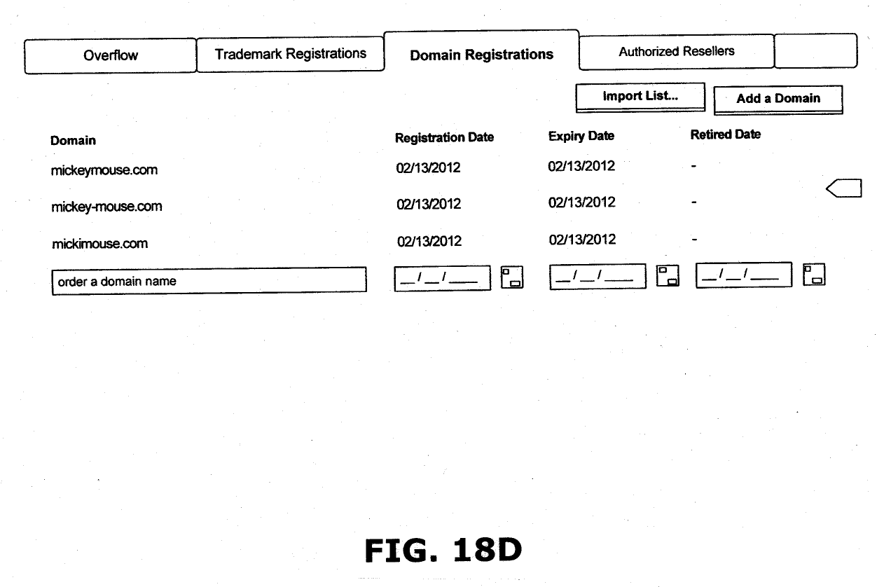

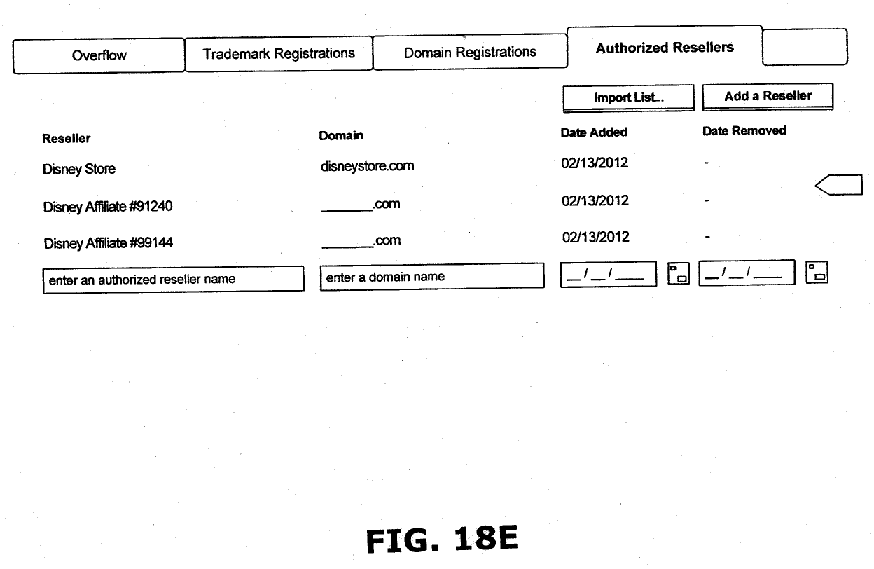

FIGS. 18A through 18E illustrate an example of a trademark and domain name registration process as provided by the trademark service. FIG. 18A illustrates a trademarks page where the user can add and store the trademarks the user wishes to be covered under the protection of the trademark service. The user could be prompted to provide additional details relating to each of the stored trademark, where such details could include the stored trademark's class, any keywords associated with the trademark, known competitors in the commerce space where the trademark is used, etc.

As part of the overall trademark service, the user could be required to set an overview filter associated with each of the stored trademark. FIG. 18B illustrates such a filter, where in association with trademark Mickey Mouse, the region for capturing screenshots from any identified offending domain name is included. Further, other information, as described in FIG. 18A, such as the trademark's class, associated keywords, etc. are stored in associated with the trademark.

Additionally, as illustrated in FIG. 18C, for each trademark, the user could be required to provide the geographical regions the trademark is registered in, associated registration information of the trademark and regions the trademark should be continued to be monitored for registration status. Also, as illustrated in FIG. 18D, for each trademark, the user could be required to provide the associated domain names owned by the user, the registration and expiry information of the domain names, etc.

Further, as illustrated in FIG. 18E, the trademark service could prompt the user to provide information pertaining to authorized resellers, who are allowed to utilize the user's trademark and related domain names. By including such information in the trademark service information base, the user could not only reduce the unnecessary enforcement actions initiated by the trademark service against such authorized users, but also utilize trademark service to monitor the registration and renewal of the trademarks and domain names of the authorized resellers. The trademark service could utilize all the related information gathered regarding the trademark and associated domain names to protection the trademarks by timely renewing registrations of the trademarks and associated domain name names.

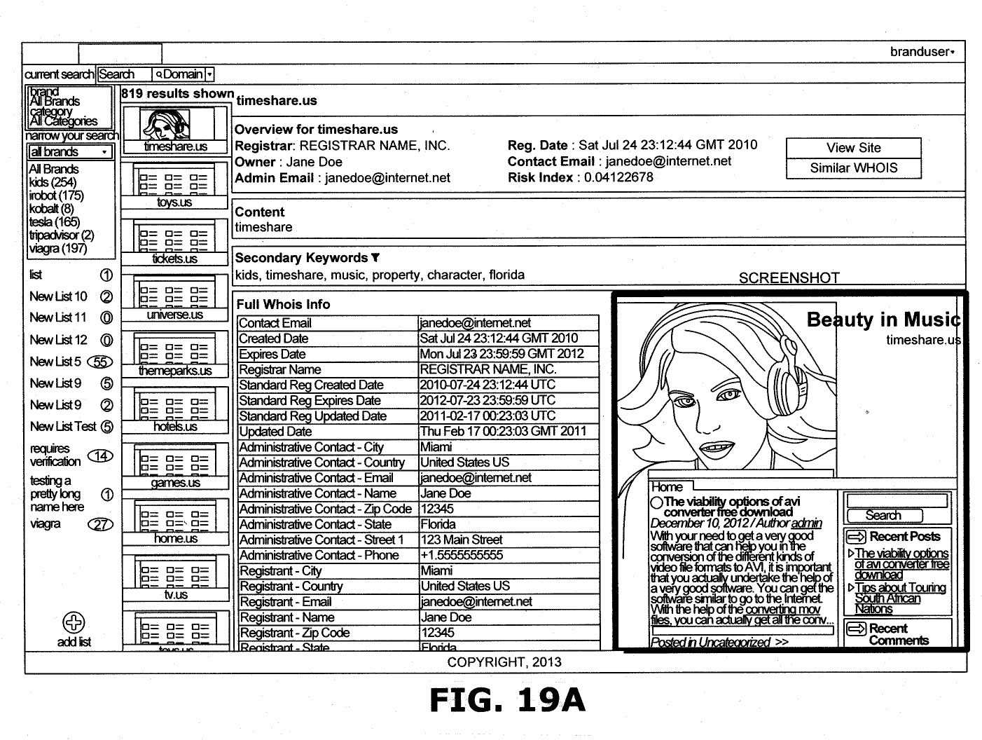

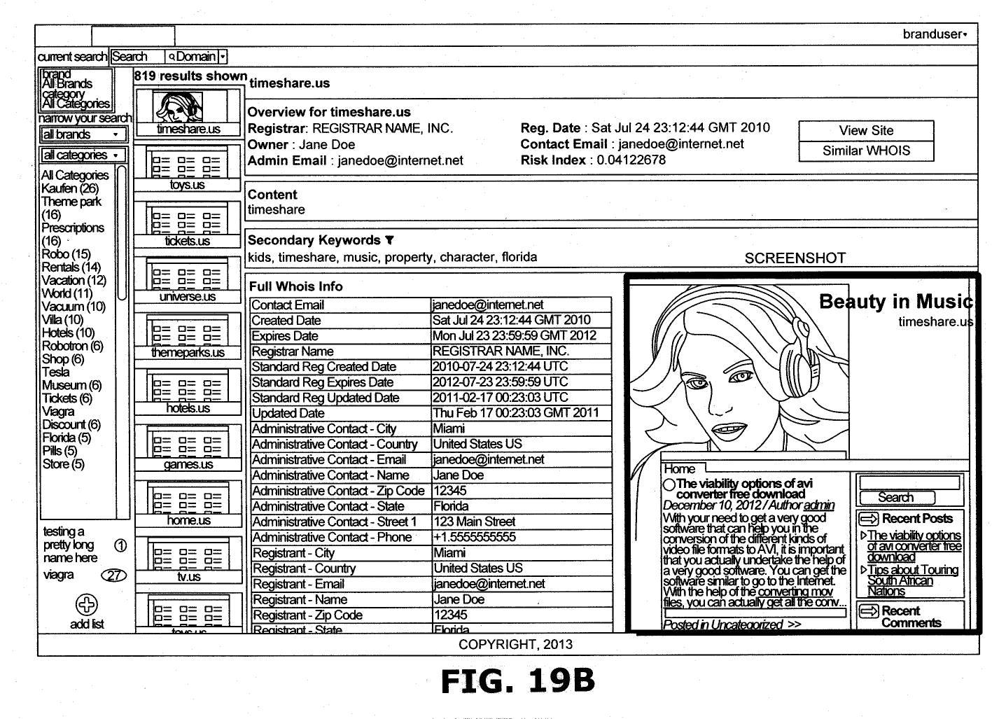

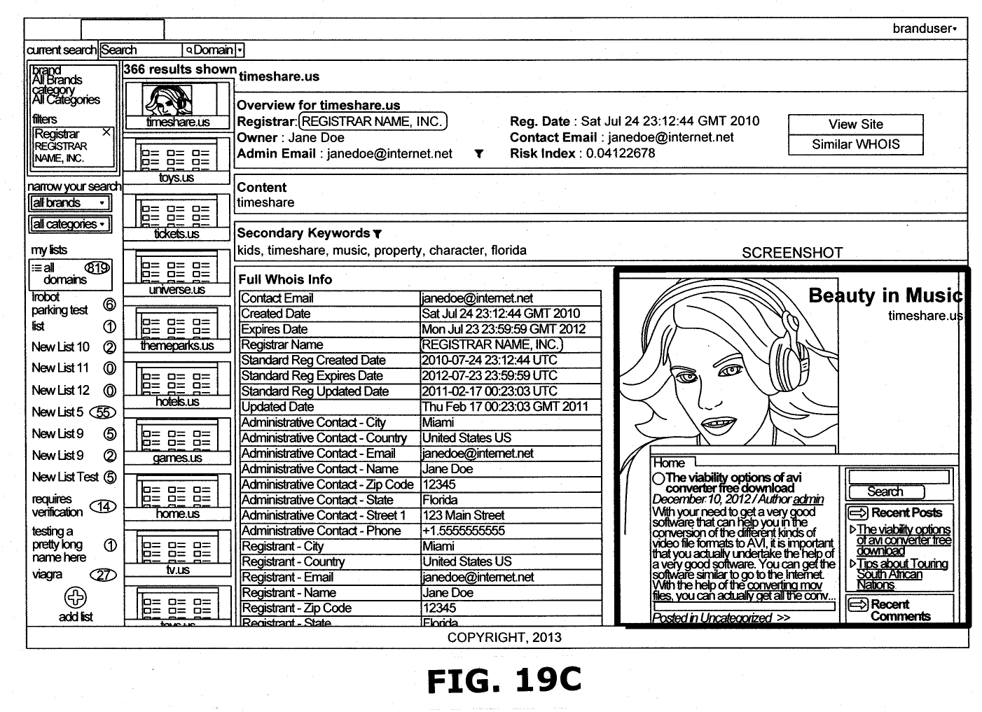

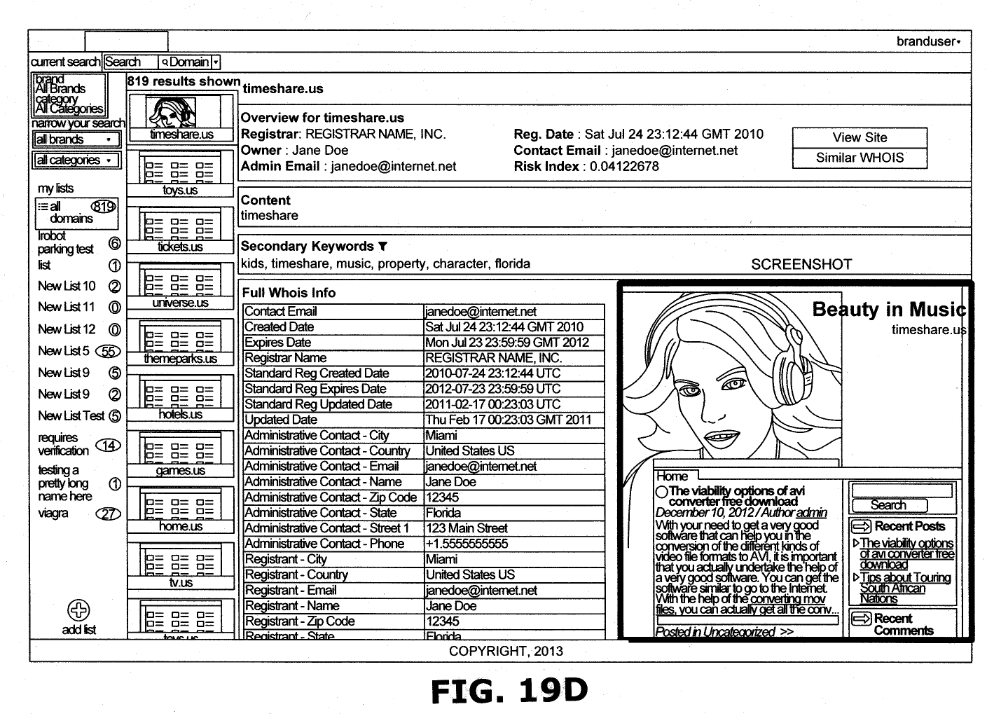

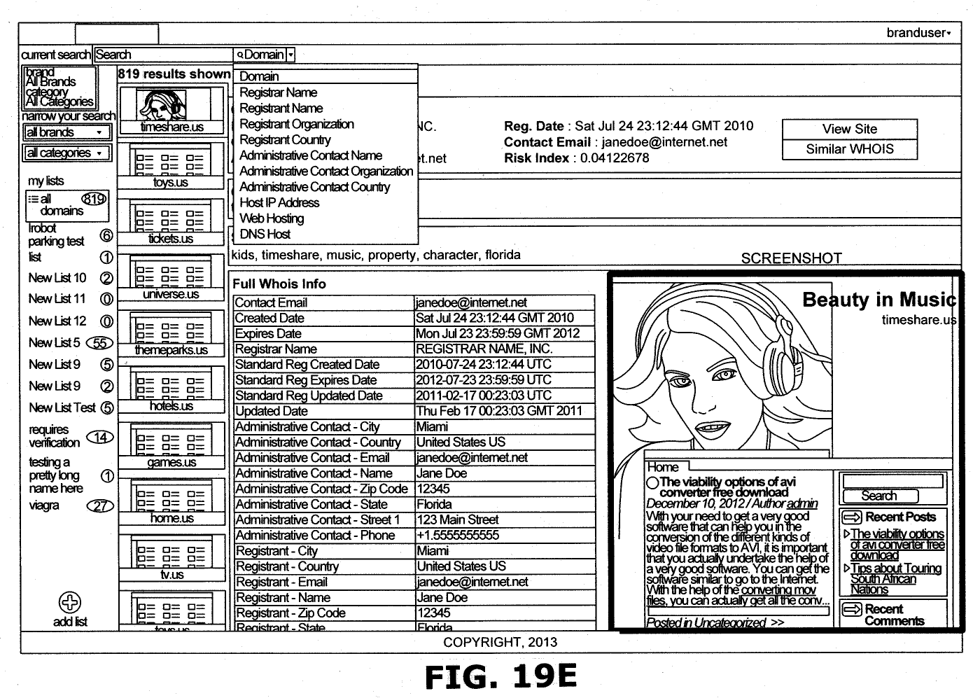

FIGS. 19A-19E illustrate examples of an enforcement dashboard offered by the trademark service. It is understood that the illustration of FIG. 19A and all ensuing figures are for the purpose of exemplary illustration only, and that other variations and designs offering the information, as may be contemplated by a person of ordinary skill in the art, are also considered equivalent variations of the techniques presented herein. The dashboard may be offered as personal software that can be installed in a user's computer, or may be simply offered as an online page via the Internet. In either scenario, the dashboard illustrated in FIGS. 19A-19E allow a user to see and navigate aggregated information regarding potentially infringing websites for one or more brands associated with the user. In addition, a user can select a particular brand, or set of brands, to review.

As illustrated in FIG. 19A, the dashboard can provide an overview of WHOIS information regarding about a particular website. In some embodiments, the user can select the fields within the WHOIS information. In response to the selection, the dashboard will create groupings by filtering the results. For example, by selecting the contact e-mail, the system will aggregate all potentially infringing websites for review. Then, the user can request that an aggregated cease and desist, or multiple cease and desist letters, be prepared with supporting documentation. As illustrated in FIGS. 19A-19E, a screenshot of the website can be presented to allow for quick review. In addition to the screenshot, content summaries (e.g., from the metadata or webpage text) can also be presented along with secondary keywords.

Grouping of websites (e.g., by brand, lists, or other filter criteria) can be shown as a column or row of smaller navigational presentations (possibly ranked based on different misuse or infringing scores) that the user can navigate though. Upon selection of one of the smaller presentations, the detailed information (e.g., WHOIS, screenshot, etc.) for that website may be populated into the main screen. This allows for a quick review by the user which can ultimately result in the sending of one or more cease and desist letters.

The dashboard can have different types of lists. For example, in some embodiments, the dashboard will support global lists that are available to all users, group lists which are available to members of a specific group (e.g., those employees associated with a specific company), or individual user lists. In some cases, the different types of lists can easily be shared with other users. The dashboard can indicate a list name for easy reference and provide an indicator of the number of entries within that list.

In some embodiments, the trademark service can create a multidimensional report based on cease and desist targets that have been identified by the user. The multidimensional reports can be generated by first making a list related to a brand or group of brands. Based on metadata (e.g., content registrant, registrar, dns provider, web host, secondary key words, etc.), the system can search wider lists and generate additional related results. From these results, the multi-dimensional reports can be generated. The reports may include an entry multiple times depending on the filters that have been set. For example, the reports can include recommendation of cease and desist letter with evidence (e.g., screenshots). The same entries may apply to sets of domains, registrants, etc.

### Exemplary Computer System Overview

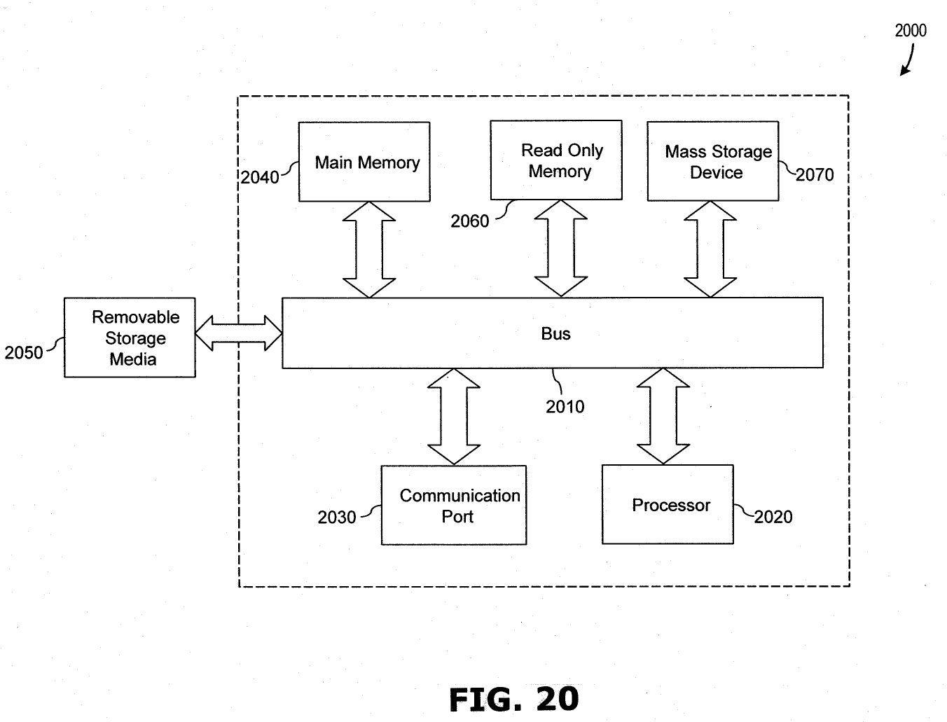

Embodiments of the present invention include various steps and operations, which have been described above. A variety of these steps and operations may be performed by hardware components or may be embodied in machine-executable instructions, which may be used to cause a general-purpose or special-purpose processor programmed with the instructions to perform the steps. Alternatively, the steps may be performed by a combination of hardware, software, and/or firmware. As such, FIG. 20 is an example of a computer system 2000 with which embodiments of the present invention may be utilized. According to the present example, the computer system includes a bus 2010, at least one processor 2020, at least one communication port 2030, a main memory 2040, a removable storage media 2010, a read only memory 2060, and a mass storage 2070.

Processor(s) 2020 can be any known processor, such as, but not limited to, an Intel® Itanium® or Itanium 2® processor(s), or AMD® Opteron® or Athlon MP® processor(s), or Motorola® lines of processors. Communication port(s) 2030 can be any of an RS-232 port for use with a modem based dialup connection, a 10/100 Ethernet port, or a Gigabit port using copper or fiber. Communication port(s) 2030 may be chosen depending on a network such a Local Area Network (LAN), Wide Area Network (WAN), or any network to which the computer system 2000 connects.

Main memory 2040 can be Random Access Memory (RAM), or any other dynamic storage device(s) commonly known in the art. Read only memory 2060 can be any static storage device(s) such as Programmable Read Only Memory (PROM) chips for storing static information such as instructions for processor 2020.

Mass storage 2070 can be used to store information and instructions. For example, hard disks such as the Adaptec® family of SCSI drives, an optical disc, an array of disks such as RAID, such as the Adaptec family of RAID drives, or any other mass storage devices may be used.

Bus 2010 communicatively couples processor(s) 2020 with the other memory, storage and communication blocks. Bus 2010 can be a PCI/PCI-X or SCSI based system bus depending on the storage devices used.

Removable storage media 2050 can be any kind of external hard-drives, floppy drives, IOMEGA® Zip Drives, Compact Disc-Read Only Memory (CD-ROM), Compact Disc-Re-Writable (CD-RW), Digital Video Disk-Read Only Memory (DVD-ROM).

The components described above are meant to exemplify some types of possibilities. In no way should the aforementioned examples limit the scope of the invention, as they are only exemplary embodiments.

In conclusion, the present invention provides novel systems, methods and arrangements for brand enforcement. While detailed descriptions of one or more embodiments of the invention have been given above, various alternatives, modifications, and equivalents will be apparent to those skilled in the art without varying from the spirit of the invention. For example, while the embodiments described above refer to particular features, the scope of this invention also includes embodiments having different combinations of features and embodiments that do not include all of the described features. Accordingly, the scope of the present invention is intended to embrace all such alternatives, modifications, and variations as fall within the scope of the claims, together with all equivalents thereof. Therefore, the above description should not be taken as limiting the scope of the invention, which is defined by the appended claims.

What is claimed is:

1. A method comprising:
receiving search data related to a plurality of entity names;
submitting, via a network, the search data related to the plurality of entity names to a brand enforcement engine to identify a set of domains of interest;
receiving, from the brand enforcement engine, tracking data that includes information regarding the set of domains by the brand enforcement engine; and
generating, using a processor, a dashboard populated with a summary of the tracking data organized by the plurality of entity names.

2. The method of claim 1, wherein the tracking data includes images from the set of domains of interest collected during an internet search.

3. The method of claim 1, wherein the search data includes images associated with some the plurality of entity names.

4. The method of claim 1, wherein domains of interest include domains that are selling products related to the any of the plurality of entity names.

5. The method of claim 4, wherein tracking data includes the price of the products associated with any of the plurality of entity names.

6. The method of claim 1, wherein the tracking data includes a list of available domain names related to one or more of the plurality of entity names that can be purchased.

7. The method of claim 6, wherein the tracking data includes an analysis of each domain name in the list of available domain names, wherein the analysis includes a traffic analysis, a content analysis, or a value analysis.

8. The method of claim 1, wherein the tracking data includes an enforcement value for each identified domain name.

9. The method of claim 8, further comprising displaying, upon selection of one of the plurality of entity names within the dashboard, a window that includes a results list with identified domain names associated with one of the entity names and the enforcement value.

10. The method of claim 9, wherein the window includes a categorization of the identified domain names into a plurality of categories.

11. The method of claim 10, wherein the categorization includes a spam category, a social media category, a news category, or a phishing category.

12. The method of claim 1, further comprising automatically generating a cease and desist letter related to one of the plurality of domains of interest.

13. The method of claim 1, wherein there cease and desist letter includes a screenshot of the domain of interest.

14. A brand enforcement system comprising:
a portal allowing a user to access a brand enforcement engine and a set of databases, wherein a set of trademarks is associated with the user;
an interface module to generate a dashboard presenting potentially infringing domain names associated with the set of trademarks; and
an enforcement module to receive a request from the user to enforce one of the trademarks and to initiate an enforcement action upon receiving the request from the user.

15. The system of claim 14, wherein the potentially infringing domain names are ranked and ordered on the dashboard.

16. The system of claim 14, further comprising an analysis module to generate an analysis of one of the potentially infringing domain names upon selection by the user.

17. The system of claim 14, further comprising a relation module to generate a set of secondary entity names related to the set of trademarks and to generate a relevance score associated with each of the secondary entity names.

18. The system of claim 17, wherein the dashboard presents the set of secondary entity names related to the set of trademarks and the relevance score associated with each of the secondary entity names.

19. The system of claim 17, wherein the relation module generates the relevance score based on one or more of:
the degree of phonetic similarity between a given secondary entity name and one of the trademarks from the set of trademarks;
the degree of likelihood the given secondary entity name is a typo of one of the trademarks from the set of trademarks; or
a yearly revenue earned by an owner of the given secondary entity name.

20. The system of claim 14, wherein the set of databases include a plurality of entries that are each associated with websites indexed based on the set of trademarks.

21. The system of claim 14, further comprising a verification module to authenticate a user and determine the user's authorization rights for initiating an enforcement action.

22. A computer-implemented method comprising:
generating, using a processor, a snapshot interface with a list of entity names received from a brand enforcement engine in response to a submission of target names;
displaying the snapshot interface on a terminal device, wherein the snapshot interface includes a statistical summary of infringers organized by the target names; and
displaying an enforcement interface upon selection of one of the target names, wherein the enforcement interface indicates existing enforcement actions and allows a user to initiate an enforcement action.

23. The computer-implemented method of claim 22, further comprising determining an enforcement authorization status of a user, wherein the enforcement authorization includes a senior level and a junior level.

24. The computer-implemented method of claim 23, wherein if the user has a senior level enforcement authorization, then the enforcement action submitted through the enforcement interface is automatically approved and if the user has a junior level enforcement authorization, then the enforcement action submitted through the enforcement interface is forwarded to a second user for review.

25. The computer-implemented method of claim 22, wherein each entity name corresponds to a trademark name or an internet domain name.

26. The computer-implemented method of claim 22, wherein generating the snapshot interface further comprises:
identifying a set of secondary entity names identified since a previous time the snapshot interface was displayed; and
enabling the user to prioritize monitoring actions on the set of secondary entity names.

27. The computer-implemented method of claim 26, further comprising computing a relevance score for each secondary entity name in relation to the target names, wherein the relevance score indicates a degree of relatedness between the secondary entity names and the target names.

28. The computer-implemented method of claim 27, wherein the relevance score of each of the secondary entity names is based on one or more of:
the degree of phonetic similarity between a given secondary entity name and a given target name;
the degree of likelihood the given secondary entity name is a typo of the target name when the target name is provided using a keyboard; or
a yearly revenue earned by an owner of the given secondary entity name.

29. The computer-implemented method of claim 26, wherein the snapshot interface includes one or more of:
an indicator of a total number of secondary entity names relevant to the target entity name;
an indicator of a total number of new secondary entity names that were identified since the previous time the snapshot interface was displayed to the user;
an indicator of a total number of secondary entity names the user has marked up for further monitoring or tracking;
an indicator of a total number of secondary entity names with updated internal information;
an indicator of a list of secondary entity names that are available for acquisition;
an indicator of a list of secondary entity names that are available for drop-catching;
an indicator of a list of secondary entity names that are identified as spam domains; or
an indicator of a list of secondary entity names that are identified as defensive trademark registrants.

30. A system comprising:
means for generating a dashboard having presented thereon data relating to one or more websites potentially misusing brands identified by a user;
means for organizing the data relating to the one or more websites by brand or groups of brands; and
means for generating a cease and desist letters upon selection of one of the target names or groups, wherein the cease and desist letters include supporting information identifying misuse of the one or more brands.

31. The system of claim 30, further comprising means for generating an analysis of one of the websites upon selection by the user.

32. The system of claim 30, means for generating a set of secondary entity names related to the brands.
